(19) United States
(12) Patent Application Publication
(10) Pub. No.: US 2012/0282936 A1
(43) Pub. Date: Nov. 8, 2012

(54) Methods of PDCCH Capacity Enhancement in LTE Systems

(75) Inventors: Shiwei Gao, Nepean (CA); Hua Xu, Ottawa (CA); Dongsheng Yu, Ottawa (CA); Shiguang Guo, Kitchener (CA)

(73) Assignee: RESEARCH IN MOTION LIMITED, Waterloo (CA)

(21) Appl. No.: 13/169,856

(22) Filed: Jun. 27, 2011

Related U.S. Application Data
(60) Provisional application No. 61/481,571, filed on May 2, 2011.

(51) Int. Cl. H04W 72/12

(52) U.S. Cl. 455/450

(57) ABSTRACT

A method is provided for transmitting data scheduling information from at least one transmission point in a cell in a wireless telecommunication system. The method comprises, in a procedure for generating a PDCCH, the at least one transmission point inserting a DMRS into at least one resource element in at least one REG in at least one CCE that contains the PDCCH, wherein the PDCCH is intended only for at least one specific UE.

### CROSS-REFERENCE TO RELATED APPLICATIONS

The present application claims priority to U.S. Provisional Patent Application No. 61/481,571, filed May 2, 2011 by Shiwei Gao, et al., entitled “Method of PDCCH Capacity Enhancement in LTE Systems” which is incorporated by reference herein as if reproduced in its entirety.

### BACKGROUND

As used herein, the terms “user equipment” and “UE” might in some cases refer to mobile devices such as mobile telephones, personal digital assistants, handheld or laptop computers, and similar devices that have telecommunications capabilities. Such a UE might consist of a device and its associated removable memory module, such as but not limited to a Universal Integrated Circuit Card (UICC) that includes a Subscriber Identity Module (SIM) application, a Universal Subscriber Identity Module (USIM) application, or a Removable User Identity Module (R-UIM) application. Alternatively, such a UE might consist of the device itself without such a module. In other cases, the term “UE” might refer to devices that have similar capabilities but that are not transportable, such as desktop computers, set-top boxes, or network appliances. The term “UE” can also refer to any hardware or software component that can terminate a communication session for a user. Also, the terms “user equipment,” “UE,” “user agent,” “UA,” “user device,” and “mobile device” might be used synonymously herein.

As telecommunications technology has evolved, more advanced network access equipment has been introduced that can provide services that were not possible previously. This network access equipment might include systems and devices that are improvements of the equivalent equipment in a traditional wireless telecommunications system. Such advanced or next generation equipment may be included in evolving wireless communications standards, such as long-term evolution (LTE). For example, an LTE system might include an Evolved Universal Terrestrial Radio Access Network (E-UTRAN) node B (eNB), a wireless access point, or a similar component rather than a traditional base station. Any such component will be referred to herein as an eNB, but it should be understood that such a component is not necessarily an eNB.

LTE may be said to correspond to Third Generation Partnership Project (3GPP) Release 8 (Rel-8 or R8), Release 9 (Rel-9 or R9), and Release 10 (Rel-10 or R10), and possibly also to releases beyond Release 10, while LTE Advanced (LTE-A) may be said to correspond to Release 10 and possibly also to releases beyond Release 10. As used herein, the terms “legacy”, “legacy UE”, and the like might refer to signals, UEs, and/or other entities that comply with LTE Release 10 and/or earlier releases but do not comply with releases later than Release 10. The terms “advanced”, “advanced UE”, and the like might refer to signals, UEs, and/or other entities that comply with LTE Release 11 and/or later releases. While the discussion herein deals with LTE systems, the concepts are equally applicable to other wireless systems as well.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a diagram of a downlink LTE subframe, according to an embodiment of the disclosure.

FIG. 2 is a diagram of an LTE downlink resource grid, according to an embodiment of the disclosure.

FIG. 3 is a diagram of a mapping of a cell-specific reference signal in a resource block in the case of two antenna ports at an eNB, according to an embodiment of the disclosure.

FIG. 4 is a diagram of a resource element group allocation in a resource block in the first slot when two antenna ports are configured at an eNB, according to an embodiment of the disclosure.

FIG. 5 is a diagram of an example of a remote radio head (RRH) deployment in a cell, according to an embodiment of the disclosure.

FIG. 6 is a block diagram of an RRH deployment with a separate central control unit for coordination between a macro-eNB and the RRHs, according to an embodiment of the disclosure.

FIG. 7 is a block diagram of an RRH deployment where coordination is done by the macro-eNB, according to an embodiment of the disclosure.

FIG. 8 is a diagram of an example of possible transmission schemes in a cell with RRHs, according to an embodiment of the disclosure.

FIG. 9 is a conceptual diagram of physical downlink control channel (PDCCH) allocations at different transmission points, according to an embodiment of the disclosure.

FIG. 10 is a conceptual diagram of a UE-PDCCH-DMRS allocation, according to an embodiment of the disclosure.

FIG. 11 is a diagram of an example of a pre-coded transmission of a PDCCH with a UE-PDCCH-DMRS, according to an embodiment of the disclosure.

FIG. 12 is a diagram of an example of cycling through a predetermined set of precoding vectors, according to an embodiment of the disclosure.

FIG. 13 is a diagram of legacy PDCCH processing at a transmission point with four antennas.

FIG. 14 is a diagram of an example of a PDCCH implementation for a PDCCH with a UE-PDCCH-DMRS at a transmission point with four antennas, according to an embodiment of the disclosure.

FIG. 15 is a diagram of an example of a scrambling process for both legacy PDCCHs and advanced PDCCHs, according to an embodiment of the disclosure.

FIG. 16 is a diagram of an example of a scrambling process for both legacy PDCCHs and advanced PDCCHs with advanced cell-specific scrambling sequences, according to an embodiment of the disclosure.

FIG. 17 is a diagram of an example of UE-PDCCH-DMRS insertion, according to an embodiment of the disclosure.

FIG. 18 is a diagram of an example of multiplexing of two PDCCHs with a UE-PDCCH-DMRS, according to an embodiment of the disclosure.

FIG. 19 is a diagram of an example of resource element group determination from a candidate PDCCH, according to an embodiment of the disclosure.

FIG. 20 contains tables related to embodiments of the disclosure.

FIG. 21 illustrates a processor and related components suitable for implementing the several embodiments of the present disclosure.

### DETAILED DESCRIPTION

It should be understood at the outset that although illustrative implementations of one or more embodiments of the present disclosure are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

The present disclosure deals with cells that include one or more remote radio heads in addition to an eNB. Implementations are provided whereby such cells can take advantage of the capabilities of advanced UEs while still allowing legacy UEs to operate in their traditional manner. More specifically, a UE-specific signal is introduced that allows a UE to demodulate its control channels without the need of a cell-specific reference signal.

In an LTE system, physical downlink control channels (PDCCHs) are used to carry downlink (DL) or uplink (UL) data scheduling information, or grants, from an eNB to one or more UEs. The scheduling information may include a resource allocation, a modulation and coding rate (or transport block size), the identity of the intended UE or UEs, and other information. A PDCCH could be intended for a single UE, multiple UEs or all UEs in a cell, depending on the nature and content of the scheduled data. A broadcast PDCCH is used to carry scheduling information for a Physical Downlink Shared Channel (PDSCH) that is intended to be received by all UEs in a cell, such as a PDSCH carrying system information about the eNB. A multicast PDCCH is intended to be received by a group of UEs in a cell. A unicast PDCCH is used to carry scheduling information for a PDSCH that is intended to be received by only a single UE.

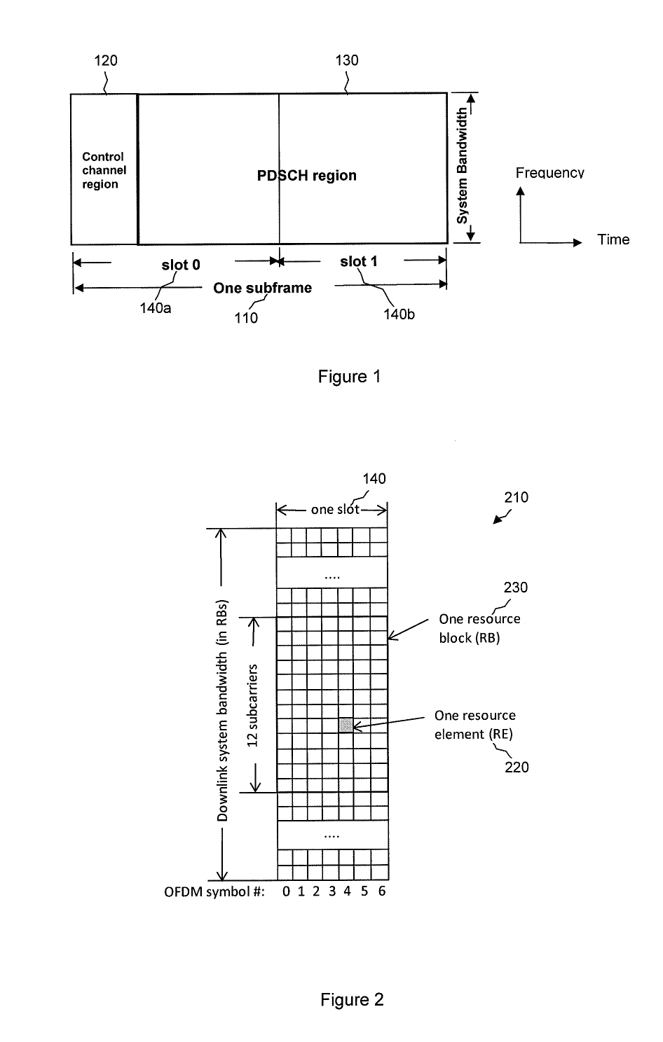

FIG. 1 illustrates a typical DL LTE subframe 110. Control information such as the PCFICH (physical control format indicator channel), PHICH (physical HARQ (hybrid automatic repeat request) indicator channel), and PDCCH are transmitted in a control channel region 120. The control channel region 120 consists of the first few OFDM (orthogonal frequency division multiplexing) symbols in the subframe 110. The exact number of OFDM symbols for the control channel region 120 is either dynamically indicated by PCFICH, which is transmitted in the first symbol, or semi-statically configured in the case of carrier aggregation in LTE Rel-10.

The PDSCH, PBCH (physical broadcast channel), PSC/SSC (primary synchronization channel/secondary synchronization channel), and CSI-RS (channel state information reference signal) are transmitted in a PDSCH region 130. DL user data is carried by the PDSCH channels scheduled in the PDSCH region 130. Cell-specific reference signals (CRS) are transmitted over both the control channel region 120 and the PDSCH region 130.

Each subframe 110 consists of a number of OFDM symbols in the time domain and a number of subcarriers in the frequency domain. An OFDM symbol in time and a subcarrier in frequency together define a resource element (RE). A physical resource block (RB) can be defined as 12 consecutive subcarriers in the frequency domain and all the OFDM symbols in a slot in the time domain. An RB pair with the same RB index in slot 0 140a and slot 1 140b in a subframe are always allocated together.

FIG. 2 shows an LTE DL resource grid 210 within each slot 140 in the case of a normal cyclic prefix (CP) configuration. The resource grid 210 is defined for each antenna port, i.e., each antenna port has its own separate resource grid 210. Each element in the resource grid 210 for an antenna port is an RE 220, which is uniquely identified by an index pair of a subcarrier and an OFDM symbol in a slot 140. An RB 230 consists of a number of consecutive subcarriers in the frequency domain and a number of consecutive OFDM symbols in the time domain as shown in the figure. An RB 230 is the minimum unit used for the mapping of certain physical channels to REs 220.

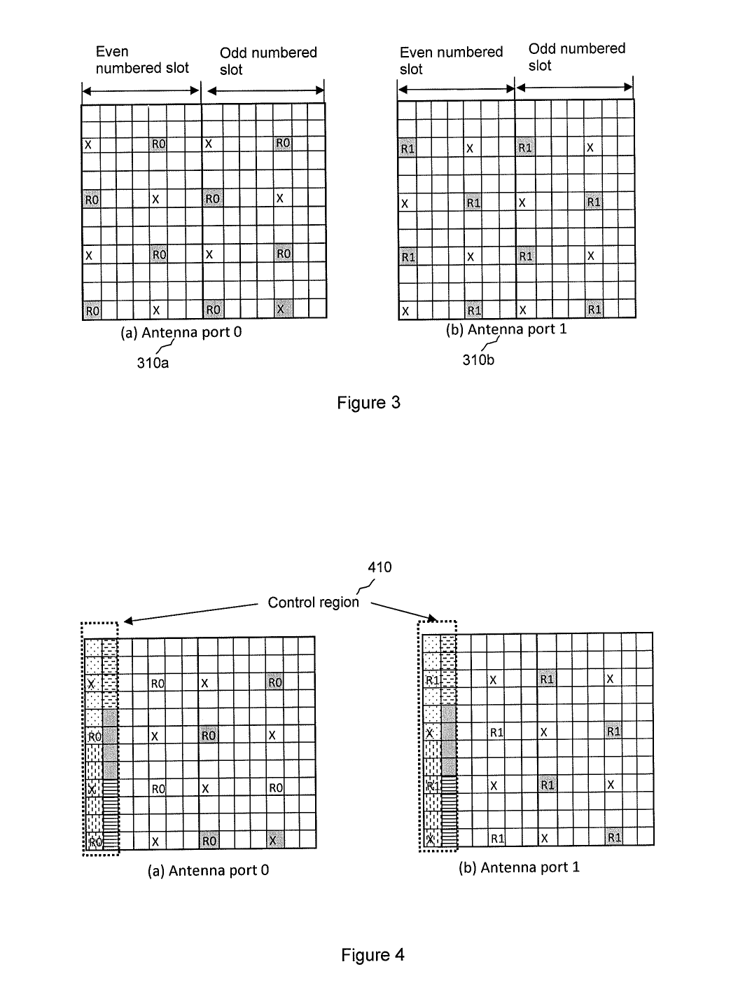

For DL channel estimation and demodulation purposes, cell-specific reference signals (CRS) are transmitted over each antenna port on certain predefined time and frequency REs in every subframe. CRS are used by Rel-8 to Rel-10 legacy UEs to demodulate the control channels. FIG. 3 shows an example of CRS locations in a subframe for two antenna ports 310a and 310b, where the RE locations marked with “R0” and “R1” are used for CRS port 0 and CRS port 1 transmission, respectively. REs marked with “X” indicate that nothing should be transmitted on those REs, as CRS will be transmitted on the other antenna.

Resource element groups (REGs) are used in LTE for defining the mapping of control channels such as the PDCCH to REs. An REG consists of either four or six consecutive REs in an OFDM symbol, depending on the number of CRS configured. For example, for the two antenna port CRS as shown in FIG. 3, the REG allocation in each RB is shown in FIG. 4, where the control region 410 consists of two OFDM symbols and different REGs are indicated with different types of shading. REs marked with “R0”,“R1” or “X” are reserved for other purposes, and therefore only four REs in each REG are available for carrying control channel data.

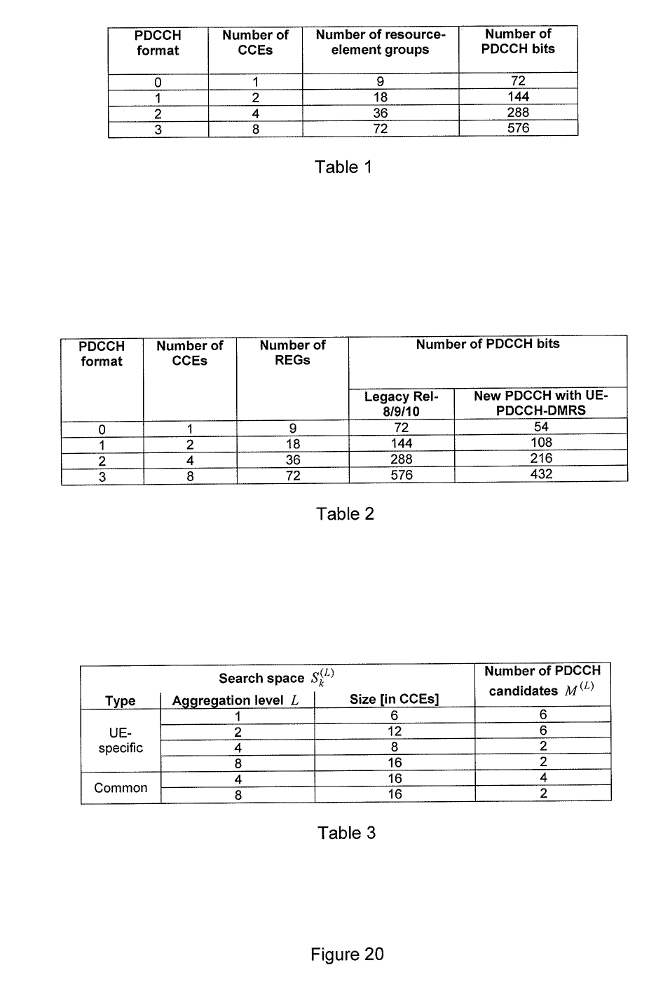

A PDCCH is transmitted on an aggregation of one or several consecutive control channel elements (CCEs), where one CCE consists of nine REGs. The CCEs available for a UE's PDCCH transmission are numbered from 0 to n_{CCE}−1. In LTE, multiple formats are supported for the PDCCH as shown in Table 1 of FIG. 20.

The demand on wireless data services has grown exponentially, driven particularly by the popularity of smart phones. To meet this growing demand, new generations of wireless standards with both multiple input and multiple output (MIMO) and orthogonal frequency division multiple access (OFDMA) and/or single carrier—frequency division multiple access (SC-FDMA) technologies have been adopted in next generation wireless standards such as 3GPP LTE and WIMAX (Worldwide Interoperability for Microwave Access). In these new standards, the peak DL and UL data rates for the whole cell or a UE can be greatly improved with the MIMO technique, especially when there is a good signal to interference and noise ratio (SINR) at the UE. This is typically achieved when a UE is close to an eNB. Much lower data rates are typically achieved for UEs that are far away from an eNB, i.e., at the cell edge, because of the lower SINR experienced at these UEs due to large propagation losses or high interference levels from adjacent cells, especially in a small cell scenario. Thus, depending on where a UE is located in a cell, different user experiences may be expected by different UEs.

To provide a more consistent user experience, remote radio heads (RRH) with one, two or four antennas may be placed in the areas of a cell where the SINR from the eNB is low to provide better coverage for UEs in those areas. RRHs are sometimes referred to by other names such as remote radio units or remote antennas, and the term “RRH” as used herein should be understood as referring to any distributed radio device that functions as described herein. This type of RRH deployment has been under study in LTE for possible standardization in Release 11 or later releases.

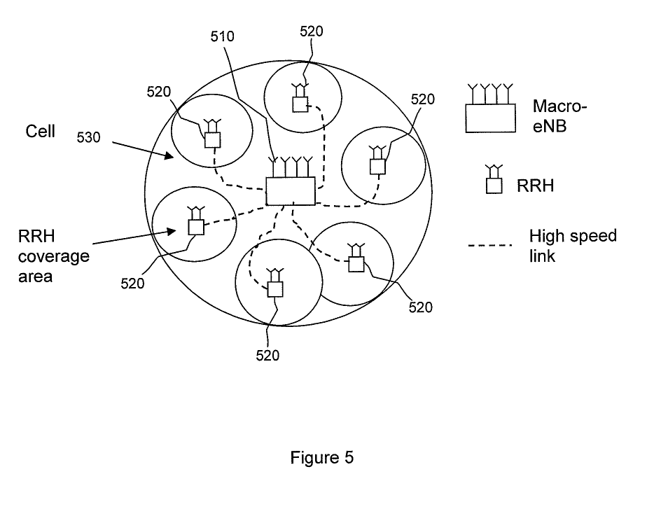

FIG. 5 shows an example of such a deployment with one eNB 510 and six RRHs 520, where the eNB 510 is located near the center of a cell 530 and the six RRHs 520 are spread in the cell 530, such as near the cell edge. An eNB that is deployed with a plurality of RRHs in this manner can be referred to as a macro-eNB. A cell is defined by the coverage of the macro-eNB, which may or may not be located at the center of a cell. The RRHs may or may not be within the coverage of the macro-eNB. In general, the macro-eNB need not always have a collocated radio transceiver and can be considered a device that exchanges data with and controls radio transceivers. The term “transmission point” (TP) may be used herein to refer to either a macro-eNB or an RRH. A macro-eNB or an RRH can be considered a TP with a number of antenna ports.

The RRHs 520 might be connected to the macro-eNB 510 via high capacity and low latency links, such as CPRI (common public radio interface) over optical fiber, to send and receive either digitized baseband signals or radio frequency signals to and from the macro-eNB 510. In addition to coverage enhancement, another benefit of the use of RRHs is an improvement in overall cell capacity. This is especially beneficial in hot-spots, where the UE density may be higher.

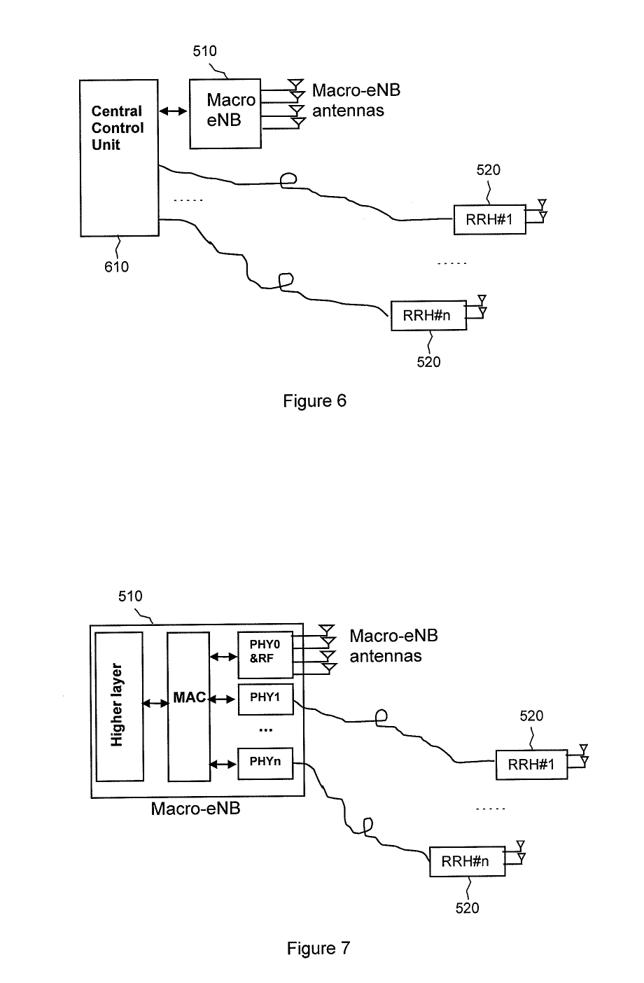

When RRHs are deployed in a cell, there are at least two possible system implementations. In one implementation, as shown in FIG. 6, each RRH 520 may have built-in, full MAC (Medium Access Control) and PHY (Physical) layer functions, but the MAC and the PHY functions of all the RRHs 520 as well as the macro-eNB 510 may be controlled by a central control unit 610. The main function of the central control unit 610 is to perform coordination between the macro-eNB 510 and the RRHs 520 for DL and UL scheduling. In another implementation, as shown in FIG. 7, the functions of the central unit could be built into the macro-eNB 510. In this case, the PHY and MAC functions of each RRH 520 could also be combined into the macro-eNB 510. When the term “macro-eNB” is used hereinafter, it may refer to either a macro-eNB separate from a central control unit or a macro-eNB with built-in central control functions.

In a deployment of one or more RRHs in a cell with a macro-eNB, there are at least two possible operation scenarios. In a first scenario, each RRH is treated as an independent cell and thus has its own cell identifier (ID). From a UE's perspective, each RRH is equivalent to an eNB in this scenario. The normal hand-off procedure is required when a UE moves from one RRH to another RRH. In a second scenario, the RRHs are treated as part of the cell of the macro-eNB. That is, the macro-eNB and the RRHs have the same cell ID. One of the benefits of the second scenario is that the hand-off between the RRHs and the macro-eNB within the cell is transparent to a UE. Another potential benefit is that better coordination may be achieved to avoid interference among the RRHs and the macro-eNB.

These benefits may make the second scenario more desirable. However, some issues may arise regarding differences in how legacy UEs and advanced UEs might receive and use the reference signals that are transmitted in a cell. Specifically, a legacy reference signal known as the cell-specific reference signal (CRS) is broadcast throughout a cell by the macro-eNB and can be used by the UEs for channel estimation and demodulation of control and shared data. The RRHs also transmit a CRS that may be the same as or different from the CRS broadcast by the macro-eNB. Under the first scenario, each RRH would transmit a unique CRS that is different from and in addition to the CRS that is broadcast by the macro-eNB. Under the second scenario, the macro-eNB and all the RRHs would transmit the same CRS.

For the second scenario, where all the RRHs deployed in a cell are assigned the same cell ID as the macro-eNB, several goals may be desirable. First, when a UE is close to one or more TPs, it may be desirable for the DL channels, such as the PDSCH and PDCCH, that are intended for that UE to be transmitted from that TP or those TPs. (Terms such as “close to” or “near” a TP are used herein to indicate that a UE would have a better DL signal strength or quality if the DL signal is transmitted to that UE from that TP rather than from a different TP.) Receiving the DL channels from a nearby TP could result in better DL signal quality and thus a higher data rate and fewer resources used for the UE. Such transmissions could also result in reduced interference to the neighboring cells.

Second, it may be desirable for the same time/frequency resources for a UE served by one TP to be reused for other UEs close to different TPs when the interferences between the TPs are negligible. This would allow for increased spectrum efficiency and thus higher data capacity in the cell.

Third, in the case where a UE sees comparable DL signal levels from a plurality of TPs, it may be desirable for the DL channels intended for the UE to be transmitted jointly from the plurality of TPs in a coordinated fashion to provide a better diversity gain and thus improved signal quality and possibly improved data throughput.

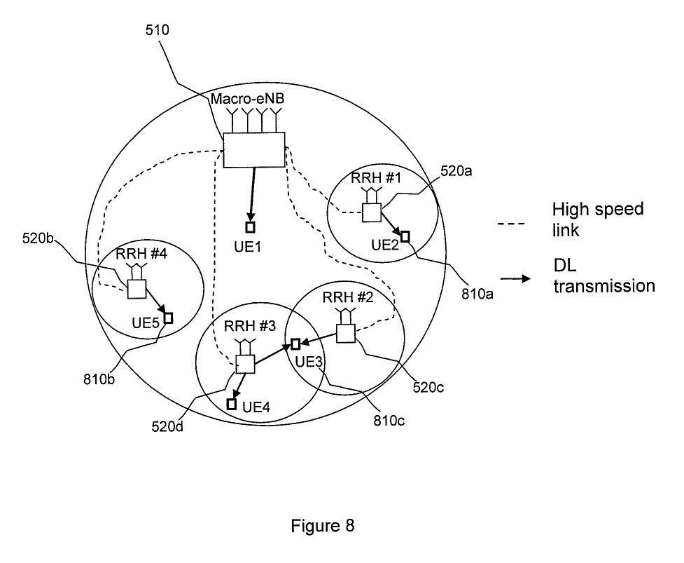

An example of a mixed macro-eNB/RRH cell in which an attempt to achieve these goals might be implemented is illustrated in FIG. 8. It may be desirable for the DL channels for UE2 810a to be transmitted only from RRH#1 520a. Similarly, the DL channels to UE5 810b may be sent only from RRH#4 520b. In addition, it may be allowable for the same time/frequency resources used for UE2 810a to be reused by UE5 810b due to the large spatial separation of RRH #1 520a and RRH #4 520b. Also, it may be desirable for the DL channels for UE3 810c, which is covered by both RRH#2 520c and RRH#3 520d, to be transmitted jointly from both RRH#2 520c and RRH#3 520d such that the signals from the two RRHs 520c and 520d are constructively added at UE3 810c for improved signal quality.

To achieve these goals, UEs may need to be able to measure DL channel state information (CSI) for each individual TP or a set of TPs, depending on a macro-eNB request. For example, the macro-eNB 510 may need to know the DL CSI from RRH#1 520a to UE2 810a in order to transmit DL channels from RRH#1 520a to UE2 810a with proper precoding and proper modulation and coding schemes (MCS). Furthermore, to jointly transmit a DL channel from RRH#2 520c and RRH#3 520d to UE3 810c, an equivalent four-port DL CSI feedback for the two RRHs 520c and 520d from UE3 810c may be needed. However, these kinds of DL CSI feedback cannot be easily achieved with the Rel-8/9 CRS for one or more of the following reasons.

First, a CRS is transmitted on every subframe and on each antenna port. A CRS antenna port, alternatively a CRS port, can be defined as the reference signal transmitted on a particular antenna port. Up to four antenna ports are supported, and the number of CRS antenna ports is indicated in the DL PBCH. CRSs are used by UEs in Rel-8/9 for DL CSI measurement and feedback, DL channel demodulation, and link quality monitoring. CRSs are also used by Rel-10 UEs for control channels such as PDCCH/PHICH demodulations and link quality monitoring. Therefore, the number of CRS ports typically needs to be the same for all UEs. Thus, a UE is typically not able to measure and feed back DL channels for a subset of TPs in a cell based on the CRS.

Second, CRSs are used by Rel-8/9 UEs for demodulation of DL channels in certain transmission modes. Therefore, DL signals typically need to be transmitted on the same set of antenna ports as the CRS in these transmission modes. This implies that DL signals for Rel-8/9 UEs may need to be transmitted on the same set of antenna ports as the CRS.

Third, CRSs are also used by Rel-8/9/10 UEs for DL control channel demodulations. Thus, the control channels typically have to be transmitted on the same antenna ports as the CRS.

In Rel-10, channel state information reference signals (CSI-RS) are introduced for DL CSI measurement and feedback by Rel-10 UEs. CSI-RS is cell-specific in the sense that a single set of CSI-RS is transmitted in each cell. Muting is also introduced in Rel-10, in which the REs of a cell's PDSCH are not transmitted so that a UE can measure the DL CSI from neighbor cells.

In addition, UE-specific demodulation reference signals (DMRS) are introduced in the DL in Rel-10 for PDSCH demodulation without a CRS. With the DL DMRS, a UE can demodulate a DL data channel without knowledge of the antenna ports or the precoding matrix being used by the eNB for the transmission. A precoding matrix allows a signal to be transmitted over multiple antenna ports with different phase shifts and amplitudes.

Therefore, CRS reference signals are no longer required for a Rel-10 UE to perform CSI feedback and data demodulation. However, CRS reference signals are still required for control channel demodulation. This means that even for a UE-specific or unicast PDCCH, the PDCCH has to be transmitted on the same antenna ports as the CRS. Therefore, with the current PDCCH design, a PDCCH cannot be transmitted from only a TP close to a UE. Thus, it is not possible to reuse the time and frequency resources for the PDCCH.

Thus, at least three problems with the existing CRS have been identified. First, the CRS cannot be used for PDCCH demodulation if a PDCCH is transmitted from antenna ports that are different from the CRS ports. Second, the CRS is not adequate for CSI feedback of individual TP information when data transmissions to a UE are desired on a TP-specific basis for capacity enhancement. Third, the CRS is not adequate for joint CSI feedback for a group of TPs for joint PDSCH transmission.

Several solutions have previously been proposed to address these problems, but each proposal has one or more drawbacks. In one previous solution, the concept of a UE-specific reference signal (RS) was proposed for PDCCH/PHICH channels to enhance capacity and coverage of these channels by techniques such as CoMP (Coordinated Multi-Point), MU-MIMO (multi-user multiple-input/multiple-output) and beamforming. The use of a UE-specific RS for PDCCH/PHICH would enable area splitting gains also for the UE-specific control channels in a shared cell-ID deployment. One proposal was to reuse the R-PDCCH (relay PDCCH) design principles described in Rel-10 for relay nodes (RNs), in which a UE-specific RS is supported. The R-PDCCH was introduced in Rel-10 for sending scheduling information from the eNB to the RNs. Due to the half-duplex nature of an RN in each DL or UL direction, the PDCCH for an RN cannot be located in the legacy control channel region (the first few OFDM symbols in a subframe) and has to be located in the legacy PDSCH region in a subframe.

A drawback with the R-PDCCH structure is that the micro-sleep feature, in which a UE can turn off its receiver in a subframe after the first few OFDM symbols if it does not detect any PDCCH in the subframe, cannot be supported because an RN has to be active in the whole subframe in order to know whether there is a PDCCH for it. This may be acceptable for an RN because an RN is considered part of the infrastructure, and power saving is a lesser concern. In addition, only ⅛ of the DL subframes can be configured for eNB-to-RN transmission, so micro-sleep is less important to a RN. The micro-sleep feature is, however, important to a UE because micro-sleep helps to reduce the power consumption of a UE and thus can increase its battery life. In addition, a UE needs to check at every subframe for a possible PDCCH, making the micro-sleep feature additionally important to a UE. Thus, retaining the micro-sleep feature for UEs would be desirable in any new PDCCH design.

In another previous solution, to support individual DL CSI feedback, it was proposed that each TP should transmit the CSI-RS on a separate CSI-RS resource. The macro-eNB handling the joint operation of all the TPs within the macro-eNB's coverage area could then configure the CSI-RS resource that a particular UE should use when estimating the DL channel for CSI feedback. A UE sufficiently close to a TP would typically be configured to measure on the CSI-RS resource used by that TP. Different UEs would thus potentially measure on different CSI-RS resources depending on the location of the UE in the cell.

The set of TPs from which a UE receives significant signals may differ from UE to UE. The CSI-RS measurement set thus may need to be configured in a UE-specific manner. It follows that the zero-power CSI-RS set also needs to support UE-specific configurations, since muting patterns need to be configured in relation to the resources used for the CSI-RS.

To restate the issues, in a first scenario, different IDs are used for the macro-eNB and the RRHs, and in a second scenario, the macro-eNB and the RRHs have the same ID. If the first scenario is deployed, the benefits of the second scenario described above could not be easily gained due to possible CRS and control channel interference between the macro-eNB and the RRHs. If these benefits are desired and the second scenario is selected, some accommodations may need to be made for the differences between the capabilities of legacy UEs and advanced UEs. A legacy UE performs channel estimation based on CRS for DL control channel (PDCCH) demodulation. A PDCCH intended for a legacy UE needs to be transmitted on the same TPs over which the CRS are transmitted. Since CRS are transmitted over all TPs, the PDCCH also needs be transmitted over all the TPs. A Rel-8 or Rel-9 UE also depends on CRS for PDSCH demodulation. Thus a PDSCH for the UE needs to be transmitted on the same TPs as the CRS. Although Rel-10 UEs do not depend on CRS for PDSCH demodulation, they may have difficulty in measuring and feeding back DL CSI for each individual TP, which is required for an eNB to send the PDSCH over only the TPs close to the UEs. An advanced UE may not depend on the CRS for PDCCH demodulation. Thus, the PDCCH for such a UE might be transmitted over only the TPs close to the UE. In addition, an advanced UE is able to measure and feed back DL CSI for each individual TP. Such capabilities of advanced UEs provide possibilities for cell operation that are not available with legacy UEs.

As an example, two advanced UEs that are widely separated in a cell may each be near an RRH, and the coverage areas of the two RRHs may not overlap. Each UE might receive a PDCCH or PDSCH from its nearby RRH. Since each UE could demodulate its PDCCH or PDSCH without CRS, each UE could receive its PDCCH and PDSCH from its nearby RRH rather than from the macro-eNB. Since the two RRHs are widely separated, the same PDCCH and PDSCH time/frequency resources could be reused in the two RRHs, thus improving the overall cell spectrum efficiency. Such cell operation is not possible with legacy UEs.

As another example, a single advanced UE might be located in an area of overlapping coverage by two RRHs and could receive and properly process CRSs from each RRH. This would allow the advanced UE to communicate with both of the RRHs, and signal quality at the UE could be improved by constructive addition of the signals from the two RRHs.

Embodiments of the present disclosure deal with the second operation scenario where the macro-eNB and the RRHs have the same cell ID. Therefore, these embodiments can provide the benefits of transparent hand-offs and improved coordination that are available under the second scenario. In addition, these embodiments allow different TPs to transmit different CSI-RS in some circumstances. This can allow cells to take advantage of the ability of advanced UEs to distinguish between CSI-RS transmitted by different TPs, thus improving the efficiency of the cells. Further, these embodiments are backward compatible with legacy UEs in that a legacy UE could still receive the same CRS or CSI-RS anywhere in a cell as it has traditionally been required to do.

In an embodiment, a UE-specific, or unicast, PDCCH for an advanced UE is allocated in the control channel region in the same way a legacy PDCCH is allocated. However, for each REG allocated to a UE-specific PDCCH for an advanced UE, one or more of the REs not allocated for the CRS are replaced with a UE-specific DMRS symbol. The UE-specific DMRS is a sequence of complex symbols carrying a UE-specific bit sequence, and thus only the intended UE is able to decode the PDCCH correctly. Such DMRS sequences could be configured explicitly by higher layer signaling or implicitly derived from the user ID.

This UE-specific DMRS for PDCCH (hereinafter referred to as the UE-PDCCH-DMRS) allows a PDCCH to be transmitted from either a single TP or multiple TPs to a UE. It also enables PDCCH transmission with more advanced techniques such as beamforming, MU-MIMO, and CoMP. In this solution, there is no change in multicast or broadcast PDCCH transmissions; they are transmitted in the common search space in the same way as in Rel-8/9/10. A UE could still decode the broadcast PDCCH using the CRS in the common search space. The UE-PDCCH-DMRS could be used to decode the unicast PDCCH.

This solution is fully backward compatible as it does not have any impact on the operation of legacy UEs. One drawback may be that there may be a resource overhead due to the UE-PDCCH-DMRS, but this overhead may be justified because fewer overall resources for the PDCCH may be needed when more advanced techniques are used.

More specifically, in an embodiment, a UE-specific PDCCH demodulation reference signal (UE-PDCCH-DMRS) is introduced for unicast PDCCH channels. The UE-PDCCH-DMRS allows a UE to estimate the DL channel and demodulate its PDCCH channels without the need of the CRS. In this way, a unicast PDCCH channel to a UE can be transmitted over antenna ports that are different from those ports for CRS transmission. Transmitting in this manner can allow the transmission of a PDCCH over one or multiple TPs that are close to the UE and therefore can exploit the benefit of RRH deployment.

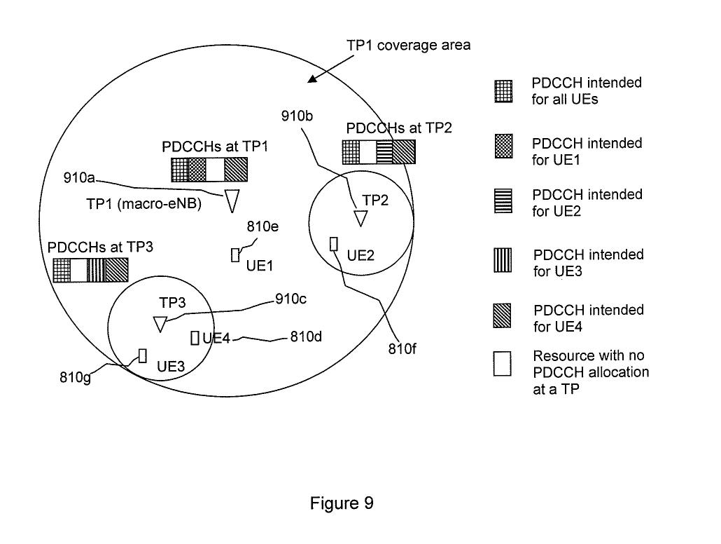

An example is shown in FIG. 9, where three TPs 910 are deployed in a cell, with TP1 910a being a macro-eNB and TP2 910b and TP3 910c being RRHs. Four UEs 810 are shown in the example with UE4 810d being a legacy Rel-8/9/10 UE and UE1 810e, UE2 810f, and UE3 810g being advanced UEs. A PDCCH intended for all the UEs 810, such as for transmission of system information, is transmitted over all the TPs 910 on the same antenna ports as those used for CRS transmission, using the legacy Rel-8 approach in the common search space. Here it is assumed that CRS reference signals are transmitted over all the TPs 910. A PDCCH intended for UE4 810d is also transmitted over all the TPs on the same antenna ports as those used for CRS transmission, using the legacy Rel-8 approach.

A PDCCH intended for one of UE1 810e, UE2 810f, and UE3 810g might be transmitted over only the TP 910 which is close to that UE 810, using the advanced approach with the UE-PDCCH-DMRS. The same PDCCH resources may be reused for a UE 810 in the coverage of a different TP 910 if there is sufficiently low interference. For example, the PDCCH resource for UE2 810f in TP2 910b may be reused for UE3 810g in TP3 910c, as shown in the figure.

The coverage of the macro-eNB (i.e., TP1 910a) overlaps with all the other TPs 910. Therefore, PDCCH resources cannot be reused between TP1 910a and the other TPs 910.

So at each TP 910, two sets of PDCCHs may be transmitted, i.e., a set of legacy PDCCHs in which CRS are required for PDCCH demodulation and a set of advanced PDCCHs in which the UE-PDCCH-DMRS is used for PDCCH demodulation. Resources used for PDCCH transmission to a legacy UE may not be reused, as they need to be transmitted with the CRS from all TPs 910. Resources used for PDCCH transmission to advanced UEs could be reused, as they may be transmitted from different TPs 910 if the coverage of the TPs 910 has no or little overlapping.

The resources allocated to a PDCCH can be one, two, four, or eight control channel elements (CCEs) or aggregation levels, as specified in Rel-8. Each CCE consists of nine REGs. Each REG consists of four or six REs that are contiguous in the frequency domain and within the same OFDM symbol. Six REs are allocated for a REG only when there are two REs reserved for the CRS within the REG. Thus, effectively only four REs in a REG are available for carrying PDCCH data.

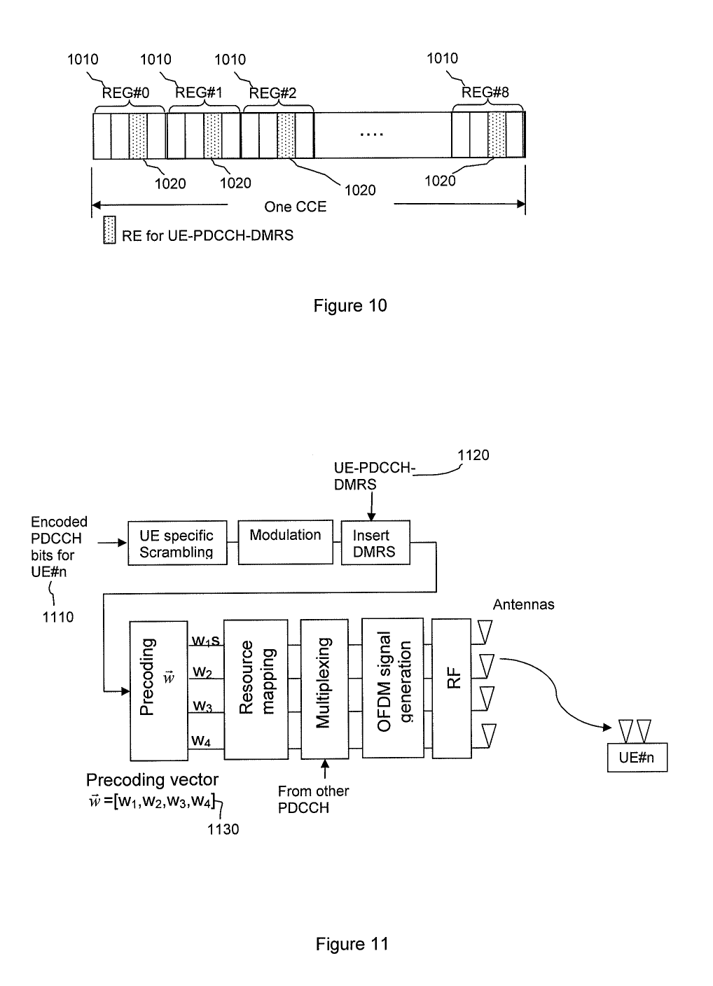

In an embodiment, a UE-specific reference signal, the UE-PDCCH-DMRS, may be inserted into each REG by replacing one RE that is not reserved for the CRS. This is shown in FIG. 10, where four non-CRS REs are shown for each REG 1010. Within each REG 1010, out of the four non-CRS REs, one RE 1020 is designated as an RE for the UE-PDCCH-DMRS. The REGs within a CCE may not be adjacent in frequency due to REG interleaving defined in Rel-8/9/10. Thus, at least one reference signal is required for each REG 1010 for channel estimation purposes. The location of the reference signal RE 1020 within each REG 1010 may be fixed or could vary from REG 1010 to REG 1010. Multiple reference signals within the REGs 1010 could also be considered to improve performance.

A UE-specific reference signal sequence may be defined for the reference REs 1020 within each CCE or over all the CCEs allocated for a PDCCH. The sequence could be derived from the 16-bit RNTI (radio network temporary identifier) assigned to a UE, the cell ID, and/or the subframe index. Thus, only the intended UE in a cell would be able to estimate the DL channel correctly and decode the PDCCH successfully. Since a CCE consists of nine REGs, a sequence length of 18 bits may be defined for a CCE if quadrature phase shift keying (QPSK) modulation is used for each reference signal RE. A sequence length of a multiple of 18 bits may be defined for aggregation levels of more than one CCE.

The presence of a reference RE in each REG for the UE-PDCCH-DMRS results in one fewer RE being available for carrying PDCCH data. This overhead may be justified because the use of UE-PDCCH-DMRS could allow a PDCCH to be transmitted from a TP close to an intended UE and thus could enable better received signal quality at the UE. That, in turn, could lead to lower CCE aggregation levels and thus increased overall PDCCH capacity. In addition, higher order modulation may be applied to compensate for the reduced number of resources due to the UE-PDCCH-DMRS overhead.

In addition, with the use of the UE-PDCCH-DMRS, a beamforming type of precoded PDCCH transmission can be used, in which a PDCCH signal is weighted and transmitted from multiple antenna ports of either a single TP or multiple TPs such that the signals are coherently combined at the intended UE. As a result, PDCCH detection performance improvement can be expected at the UE. Unlike in the CRS case where a unique reference signal is needed for each antenna port, the UE-PDCCH-DMRS can be precoded together with the PDCCH, and thus only one UE-PDCCH-DMRS is needed for a PDCCH channel regardless of the number of antenna ports used for the PDCCH transmission.

Such a PDCCH transmission example is shown in FIG. 11, where the PDCCH channel 1110 together with a UE-PDCCH-DMRS1120 is precoded with a coding vector \vec{w} 1130 before it is transmitted over the four antennas.

The precoding vector \vec{w} 1130 can be obtained from the DL wideband PMI (precoding matrix indicator) feedback from a UE configured in close loop transmission modes 4, 6 and 9 in LTE. It could be also obtained in the case where the PMI is estimated from a UL channel measurement based on channel reciprocity, such as in TDD (time division duplex) systems.

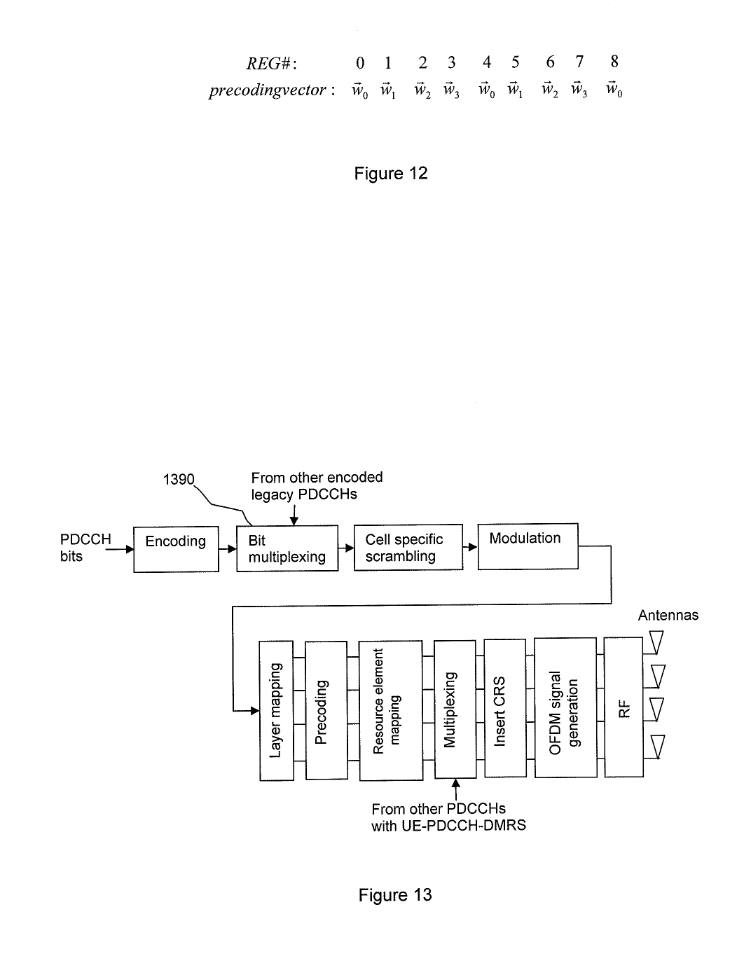

In situations where the DL PMI is not available or not reliable, a set of precoding vectors may be predefined, and each REG of a PDCCH may be precoded with one of the precoding vectors in the set. The mapping from precoding vector to REG can be done in a cyclic manner to maximize the diversity in both time and frequency. For example, if the predetermined set of precoding vectors are {\vec{w}₀,\vec{w}₁,\vec{w}₂,\vec{w}₃,} and one CCE is allocated to a PDCCH, then the mapping shown in FIG. 12 may be used. That is, precoding vectors \vec{w}₀,\vec{w}₁,\vec{w}₂,\vec{w}₃ are mapped to REGs 0, 1, 2, and 3, respectively, to REGs 4, 5, 6, and 7, respectively, and so on. In other embodiments, other mappings could be used. As the UE-PDCCH-DMRS is also precoded, the use of the precoding vector is transparent to a UE because the precoded UE-PDCCH-DMRS can be used by the UE for channel estimation and PDCCH data demodulation.

In one scenario of system operation, the CRS could be transmitted over the antenna ports of both the macro-eNB and the RRHs. Returning to FIG. 8 as an example, four CRS ports could be configured. The corresponding four CRS signals {CRS0,CRS1,CRS2,CRS3} could be transmitted as follows: CRS0 could be transmitted over antenna port 0 of all the TPs. CRS1 could be transmitted over antenna port 1 of all the TPs. CRS2 could be transmitted on antenna port 2 of the macro-eNB 510. CRS3 could be transmitted on antenna port 3 of the macro-eNB 510. In other embodiments, the CRS signals could be transmitted in other ways.

A PDCCH intended for multiple UEs in a cell or for legacy UEs could be transmitted over the same antenna ports as the CRS by assuming four CRS ports. A PDCCH intended for UE2 810a may be transmitted with the UE-PDCCH-DMRS and over only RRH1 520a with two antenna ports. Similarly, a PDCCH intended for UE5 810b may be transmitted with the UE-PDCCH-DMRS over only RRH4 520b.

Since the PDCCHs are transmitted over the TPs that are close to the intended UEs, better signal quality can be expected and thus a higher coding rate can be used. As a result, a lower aggregation level (or a smaller number of CCEs) may be used. In addition, due to the large separation between RRH#1 520a and RRH#4 520b, the same PDCCH resource could be reused in these two RRHs, which doubles the PDCCH capacity.

A unicast PDCCH intended for UE3 810c, which is covered by both RRH#2 520c and RRH#3 520d, may be transmitted jointly from both RRH#2 520c and RRH#3 520d to further enhance the PDCCH signal quality at UE3 810c.

For legacy PDCCHs, the approach to procedures such as PDCCH channel coding and rate matching, PDCCH bit multiplexing, scrambling, modulation, layer mapping, precoding, and resource element mapping can be the same as the procedures followed in Rel-8. This legacy approach is shown in FIG. 13. During the bit level multiplexing at block 1390, only the legacy PDCCHs are considered.

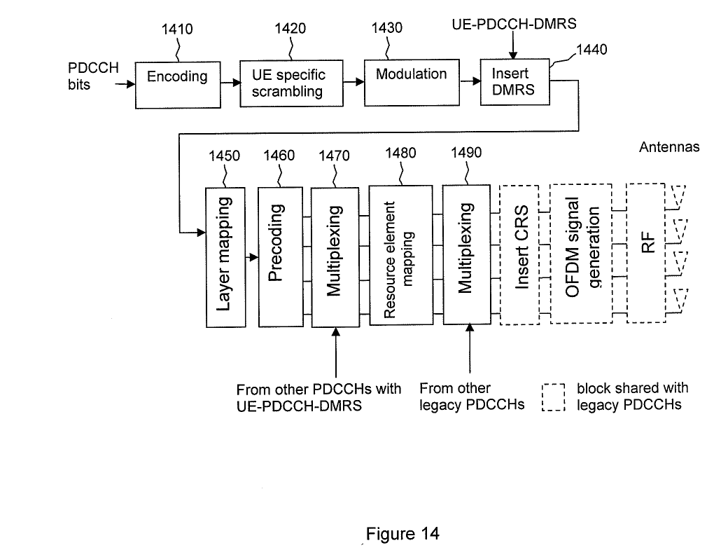

For advanced PDCCHs with the UE-PDCCH-DMRS, different procedures are implemented. Assuming one RE in each REG is used for UE-PDCCH-DMRS transmission, the number of encoded bits for the PDCCH in each CCE is 54 instead of 72 as in Rel-8 (assuming QPSK modulation for the PDCCH). An example of a PDCCH implementation with the advanced PDCCH with the UE-PDCCH-DMRS is shown in FIG. 14. In this case, the same precoding is applied to both the PDCCH and the UE-PDCCH-DMRS, which could provide precoding (beamforming) gain for PDCCH transmission. For each antenna port, the precoded symbols from each PDCCH using the UE-PDCCH-DMRS are then multiplexed before resource element mapping. Further details about the procedures followed in the blocks in FIG. 14 are provided below.

The PDCCH formats in Rel-8 as shown in Table 2 in FIG. 20 are supported except that the number of PDCCH bits for each format is different, as one RE in each REG is used for UE-PDCCH-DMRS transmission, as shown in Table 2. Here QPSK is assumed for ease of discussion, but it should be understood that other modulations such as 16 Quadrature Amplitude Modulation (16QAM) could be used. In the case of 16QAM, the number of bits for each PDCCH format in the last column of Table 2 would be doubled.

As shown in FIG. 14, the UE-PDCCH-DMRS is precoded in the same manner as the PDCCH. One UE-PDCCH-DMRS sequence per UE is needed regardless of the number of antenna ports used for PDCCH transmission. This allows the UE-PDCCH-DMRS to be supported for transmission of the PDCCH over antenna ports that may be different from the antenna used for transmission of the CRS. The UE-PDCCH-DMRS is transmitted over the same antenna port or ports as the corresponding PDCCH and is transmitted only on the CCEs upon which such a corresponding precoded PDCCH is mapped. The UE-PDCCH-DMRS is not transmitted in the REs in which the CRS is allocated, regardless of the CRS ports.

When one RE out of a group of four REs in an REG is designated for the UE-PDCCH-DMRS, as shown in FIG. 10, it may be necessary to generate a symbol sequence for the UE-PDCCH-DMRS. In an embodiment, the UE-PDCCH-DMRS symbol sequence can be defined as

$$r ( m ) = \frac{1}{\sqrt{2}} ( 1 - 2 \cdot c ( 2 m ) ) + j \frac{1}{\sqrt{2}} ( 1 - 2 \cdot c ( 2 m ) ) , \\ m = 0 , 1 , … , {M}_{r} - 1$$

where c(i) is a pseudo-random bit sequence (PRBS) generated from a pseudo-random sequence generator such as the one defined in Rel-8 and Mᵣ is the length of the UE-PDCCH-DMRS sequence and depends on the aggregation level of a PDCCH. To allow only the intended UE in a cell to correctly decode a PDCCH with the UE-PDCCH-DMRS, the PRBS generator could be initialized with the cell ID, the UE's RNTI (C-RNTI or SPS C-RNTI) and the subframe index. For example, the PRBS may be initialized at the start of each subframe as follows

cᵢₙᵢₜ=(└nₛ/2┘+1)(2N_{ID}^{cell}+1)2¹⁶+n_{RNTI}

where nₛε{0, 1, . . . , 19} is the slot index, n_{ID}^{cell}ε{0, 1, . . . , 513} is the cell ID, and n_{RNTI} is the RNTI assigned to the UE.

That is, when a UE connects to an eNB, the eNB assigns the UE a UE ID, n_{RNTI}. The cell ID and the UE ID are fed as initial seed bits into a random sequence generator which then generates a unique random sequence based on the bits. The UE can recognize that the sequence pertains to itself based on the cell ID and its UE ID.

This UE-PDCCH-DMRS sequence design allows the same PDCCH to be transmitted from more than one TP with the same sequence for enhanced PDCCH signal quality. It also enables the same PDCCH resource to be used by more than one UE covered by the same TP.

Returning to FIG. 10, it can be seen that one or more REs in each REG, which are originally allocated to the PDCCH in Rel-8 (excluding those allocated for CRS), may be allocated to carry the UE-PDCCH-DMRS. REG interleaving with a PDCCH REG from another UE, as defined in Rel-8/9/10, may be done during resource element mapping. After REG interleaving is performed, the REGs within a CCE for a UE may not be adjacent in frequency or time. Therefore, at least one reference signal is required in each REG for proper channel estimation. The location of the UE-PDCCH-DMRS RE within each REG, denoted as K_{DMRS}ε{0, 1, 2, 3}, could be predefined or signaled to the UE semi-statically. For better channel estimation, either K_{DMRS}=1 or K_{DMRS}=2 may be preferred. More than one RE could be allocated per REG to transmit the UE-PDCCH-DMRS.

The transmit power on the UE-PDCCH-DMRS could be the same as the associated PDCCH or could be higher than the PDCCH to improve the accuracy of channel estimation. If increased power on the UE-PDCCH-DMRS is transmitted, the additional power could be borrowed from the PDCCH to maintain the total transmit power unchanged within a REG. The power ratio between a UE-PDCCH-DMRS RE and a PDCCH RE could be either signaled to the UE using higher level signaling or implicitly signaled. The power ratio is only needed when high order modulation (HOM) is used on the PDCCH for PDCCH demodulation. However, if the transmit power level of the UE-PDCCH-DMRS and the PDCCH is the same, such a power level would be inherited in the UE-PDCCH-DMRS and no signaling would be required.

In other words, the UE-PDCCH-DMRS REs 1020 in FIG. 10 can be used for channel estimation. If channel conditions are poor, it may be necessary to boost the transmit power in those REs 1020 to ensure that channel estimation is done correctly. This could cause the transmit power for those REs 1020 to be different from the transmit power for the other REs in each REG 1010. In some cases, such as with QPSK modulation, signals could be decoded even when the power difference between the UE-PDCCH-DMRS REs 1020 and the other REs is not known. However, in other cases, such as with 16QAM, a received signal could not be scaled properly if the difference in amplitude between the power of the UE-PDCCH-DMRS REs 1020 and the power of the other REs is not known. In an embodiment, in such cases, the macro-eNB explicitly or implicitly signals to the UE the fact that there is a power difference between the REs and what that difference is.

Details regarding the procedures shown in FIG. 14 are now provided. It should be understood that the procedures do not necessarily need to occur in the order shown. For example, the multiplexing steps at blocks 1470 and 1490 could be performed elsewhere in the overall procedure.

For the encoding procedure at block 1410, the same PDCCH encoding procedure used in Rel-8 can be used except that the last column of Table 2 in FIG. 20 could be used to determine the number of bits for each PDCCH format. Alternatively, in an embodiment, an 8-bit cyclic redundancy code (CRC) could be used for the advanced PDCCH with the UE-PDCCH-DMRS. That is, the legacy PDCCH uses a 16-bit CRC to ensure that data is transmitted correctly. When the UE-PDCCH-DMRS is used instead of the CRS, performance may be enhanced, and it may be possible to use a CRC that is only eight bits long.

The UE-specific scrambling procedure at block 1420 will now be considered. In the current LTE, the encoded bits from all PDCCHs are concatenated and scrambled with a single cell-specific scrambling sequence, denoted here as c_{legacy}(i) of 72N_{CCE} in length, where N_{CCE} is the total number of CCEs available in a subframe. Specifically, the encoded bits b⁽⁰⁾(0), . . . , b⁽⁰⁾(M_{bit}⁽⁰⁾−1), b⁽¹⁾(0), . . . , b⁽¹⁾(M_{bit}⁽¹⁾−1), . . . , b⁽ⁿ^{_{PDCCH}}⁻¹⁾(0), . . . , b⁽ⁿ^{_{PDCCH}}⁻¹⁾(M_{bit}⁽ⁿ^{_{PDCCH}}⁻¹⁾−1) for all the legacy PDCCHs in a subframe are scrambled with the cell-specific sequence c_{legacy}(i) prior to modulation, resulting in a block of scrambled bits \tilde{b}(0), . . . , \tilde{b}(Mₜₒₜ−1) according to \tilde{b}(i)=(b(i)+c_{legacy}(i))mod 2, where Mₜₒₜ=72N_{CCE}. The scrambling sequence generator is initialized with C_{legacy,init}=└nₛ/2┘2⁹+N_{ID}^{cell} at the start of each subframe. CCE number n corresponds to bits b(72n), b(72n+1), . . . , b(72n+71).

When the advanced PDCCHs are supported, one CCE corresponds to 54 bits instead of 72 bits, breaking the rule of CCE number n corresponding to b(72n), b(72n+1), . . . , b(72n+71). For transparency to legacy UEs, the advanced PDCCHs need to be scrambled separately from the legacy PDCCHs.

In one embodiment, a UE-specific scrambling sequence is used for each advanced PDCCH. Let b₀, b₁, . . . , b_{M}_{_{bit}}₋₁ be the encoded PDCCH bits. The bits b₀, b₁, . . . , b_{M}_{_{bit}}₋₁ are then scrambled with a PRBS sequence c_{UE}(i), such as that defined in Rel-8, resulting in a block of scrambled bits \tilde{b}₀, \tilde{b}₁, . . . , \tilde{b}_{M}_{_{bit}}₋₁ according to

\tilde{b}ₖ=(bₖ′+c_{UE}(k))mod 2, k=0, 1, . . . , M_{bit}−1.

The scrambling sequence generator can be initialized with c_{UE,init}=└nₛ/2┘2⁹+N_{ID}^{cell}+n_{RNTI} at the start of each subframe.

As the bit scrambling process for the advanced PDCCH is applied only to advanced UEs, such a scrambling process can be a UE-specific process, and therefore the scrambling sequence can be generated with an RNTI (e.g., C-RNTI or SPS C-RNTI) for that particular UE. The scrambling sequence is applied only to the encoded bits of the PDCCH for that particular UE, as the UE-PDCCH-DMRS already uses the sequences with UE identifications.

In another embodiment, a new cell-specific scrambling sequence, c_{new}, of 54N_{CCE} in length, is defined for the advanced PDCCHs. The block of bits b⁽ⁱ⁾(0), . . . , b⁽ⁱ⁾(M_{bit}⁽ⁱ⁾−1) on each of the control channels to be transmitted in a subframe, where M_{bit}⁽ⁱ⁾ is the number of bits in one subframe to be transmitted on physical downlink control channel number i, is multiplexed, resulting in a block of bits)) b⁽⁰⁾(0), . . . , b⁽⁰⁾(M_{bit}⁽⁰⁾−1), b⁽¹⁾(0), . . . , b⁽¹⁾(M_{bit}⁽¹⁾−1), . . . , b⁽ⁿ^{_{PDCCH}}⁻¹⁾(0), . . . , b⁽ⁿ^{_{PDCCH}}⁻¹⁾(M_{bit}⁽ⁿ^{_{PDCCH}}⁻¹⁾−1), where n_{PDCCH} is the total number of PDCCHs transmitted in the subframe and n_{PDCCH}=n_{PDCCH}^{legacy}+n_{PDCCH}^{new}, where n_{PDCCH}^{legacy} and n_{PDCCH}^{new} are the number of legacy PDCCHs and the number of new PDCCHs, respectively. The block of bits b⁽⁰⁾(0), . . . , b⁽⁰⁾(M_{bit}⁽⁰⁾−1), b⁽¹⁾(0), . . . , b⁽¹⁾(M_{bit}⁽¹⁾−1), . . . , b⁽ⁿ^{_{PDCCH}}⁻¹⁾(0), . . . , b⁽ⁿ^{_{PDCCH}}⁻¹⁾(M_{bit}⁽ⁿ^{_{PDCCH}}⁻¹⁾−1) is scrambled with the two cell-specific sequences prior to modulation. The scrambling described next ensures that the appropriate scrambling code begins at the expected point at the starting boundary of each CCE. For legacy PDCCHs, bits on CCE number n are scrambled by c_{legacy}(72n), c_{legacy}(72n+1), . . . , c_{legacy}(72n+71), and the scrambled bits are obtained by \tilde{b}(i)=(b(i)+c_{legacy}(i))mod 2. For advanced PDCCHs, bits on CCE number n are scrambled by c_{new}(54n), c_{new}(54n+1), . . . , c_{new}(54n+53), and the scrambled bits are obtained by \tilde{b}(i)=(b(i)+c_{new}(i))mod 2. Both c_{legacy} and c_{new} are initialized with cᵢₙᵢₜ=└nₛ/2┘2⁹+N_{ID}^{cell} at the start of each subframe. The <NIL> elements, if necessary, are inserted in the block of bits prior to scrambling to ensure that the PDCCHs start at the CCE positions as described in 3GPP LTE TS 36.213.

So for the legacy PDCCHs, the same Rel-8 cell-specific scrambling sequences are generated and are applied only to the legacy PDCCHs. For advanced PDCCHs, either UE-specific scrambling sequences or a new cell-specific sequence could be generated and applied to each advanced PDCCH.

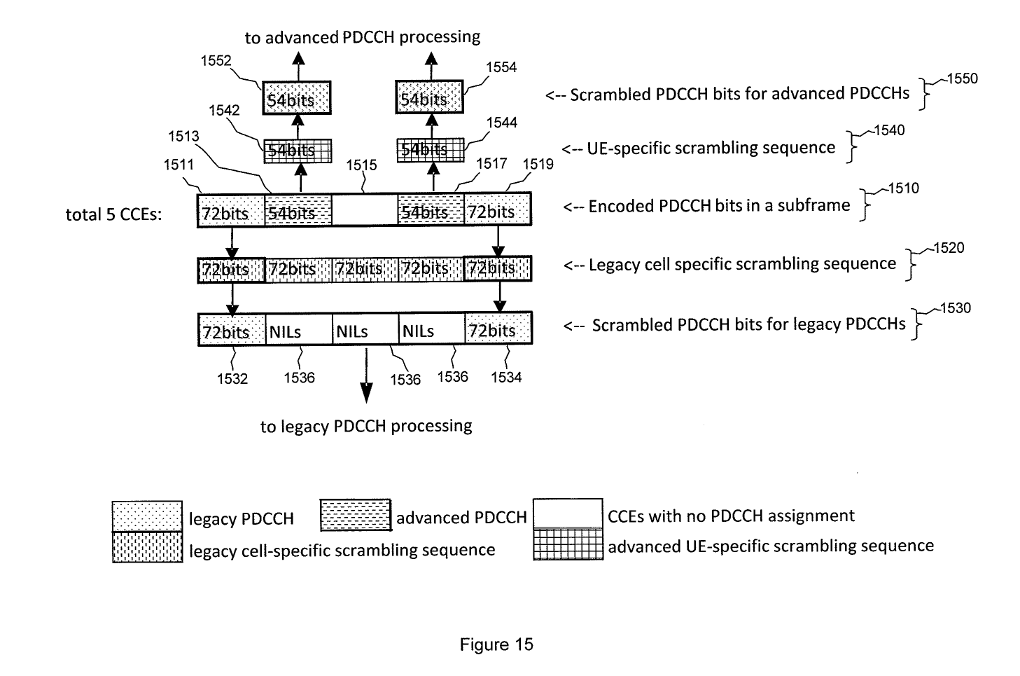

An example is shown in FIG. 15, in which a total of five CCEs are available in a subframe, and two legacy PDCCHs and two advanced PDCCHs are allocated, each in a single CCE. The presence of advanced PDCCHs is ignored in the processing of legacy PDCCHs.

That is, a PDCCH can take up one or more CCEs, and the PDCCHs for multiple UEs might be concatenated into a sequence of CCEs. An index can be used to indicate where each PDCCH begins in the sequence. Row 1510 in FIG. 15 depicts a sequence of five CCEs, four of which contain a PDCCH. The first CCE 1511 contains a legacy PDCCH, the second CCE 1513 contains an advanced PDCCH, the third CCE 1515 has no PDCCH assignment, the fourth CCE 1517 contains an advanced PDCCH, and the fifth CCE 1519 contains a legacy PDCCH.

Each CCE contains nine REGs, and each REG contains four REs. For a legacy PDCCH, all four REs in an REG carry PDCCH data, so 36 REs carry PDCCH data in a legacy PDCCH. If QPSK modulation is used, each RE can transmit two bits, so a legacy CCE contains 72 bits of PDCCH data. In an advanced PDCCH, one of the four REs in an REG is used for the UE-PDCCH-DMRS, so only three REs per REG can be used for PDCCH data. With nine REGs in a CCE, only 27 REs in an advanced CCE carry PDCCH data. So with two bits per RE, an advanced CCE contains 54 bits of PDCCH data.

When the bit-level scrambling depicted at block 1420 in FIG. 14 occurs, the CCEs in row 1510 in FIG. 15 might be scrambled in sequence from left to right. The scrambling procedure might base the expected starting point of each CCE in the sequence on the assumption that each CCE contains 72 bits of PDCCH data. Since some of the CCEs that are scrambled might contain legacy PDCCHs with 72 bits and some might contain advanced PDCCHs with 54 bits, the scrambling procedure could make an incorrect assumption regarding the starting points of the CCEs, and thus the scrambling procedure might be performed incorrectly.

For example, the fifth CCE 1519 in row 1510 is a 72-bit CCE containing a legacy PDCCH, and the second CCE 1513 and fourth CCE 1517 are 54-bit CCEs containing advanced PDCCHs. When the scrambling procedure attempts to scramble the fifth CCE 1519, the scrambling procedure might assume that all of the CCEs that were previously scrambled contained 72 bits of PDCCH data. Since two of the prior CCEs had 54 bits, the scrambling procedure would assume an incorrect starting point for the fifth CCE 1519.

In an embodiment, a scrambling procedure retains the indexes for the CCE starting points that would have been used in the legacy case. When a CCE actually contains 72 bits of PDCCH data, the CCE is processed in the legacy manner, but when a CCE contains 54 bits of PDCCH data, the CCE is processed in a different manner. This is illustrated in FIG. 15, where 5 CCEs are assumed as an example. Scrambling procedures for legacy PDCCHs are depicted in a downward direction from row 1510, and scrambling procedures for advanced PDCCHs are depicted in an upward direction from row 1510. It should be noted that PDCCHs with one CCE each are considered as an example. PDCCHs with multiple CCEs can be similarly implemented. It should be understood that, after the scrambling procedures are complete for the legacy PDCCHs and the advanced PDCCHs, both types of PDCCH are multiplexed together in a later stage of processing and transmitted in the legacy PDCCH region.

For legacy PDCCHs, a single scrambling bit sequence of 5x72 bits in length is generated at row 1520. The encoded bits of the legacy PDCCHs in row 1510 are then scrambled by the corresponding bits of the scrambling sequence at row 1520, resulting in scrambled PDCCH bits for legacy PDCCHs at row 1530. A 72-bit CCE 1532 occupies the same position in the sequence of row 1530 as the 72-bit CCE 1511 in row 1510 and is used to scramble CCE 1511, and a 72-bit CCE 1534 occupies the same position in the sequence of row 1530 as the 72-bit CCE 1519 in row 1510 and is used to scramble CCE 1519. Three nil CCEs 1536, each of 72 bits in length and having no PDCCH assignment, occupy the same CCE positions in the sequence of row 1530 as the 54-bit CCEs 1513 and 1517 and the third CCE 1515 in row 1510.

For advanced PDCCHs, two 54-bit scrambling sequences are generated at row 1540 at the same locations in the sequence as the corresponding 54-bit CCEs 1513 and 1517 in row 1510. Each of the two encoded PDCCHs of advanced UEs at row 1510 is scrambled by the corresponding UE-specific scrambling sequence in row 1540, resulting in scrambled PDCCH bits for advanced PDCCHs at row 1550. The two scrambling sequences in row 1540 are UE-specific in the sense that each of the sequences in row 1540 is generated only for the corresponding PDCCH intended for an advanced UE.

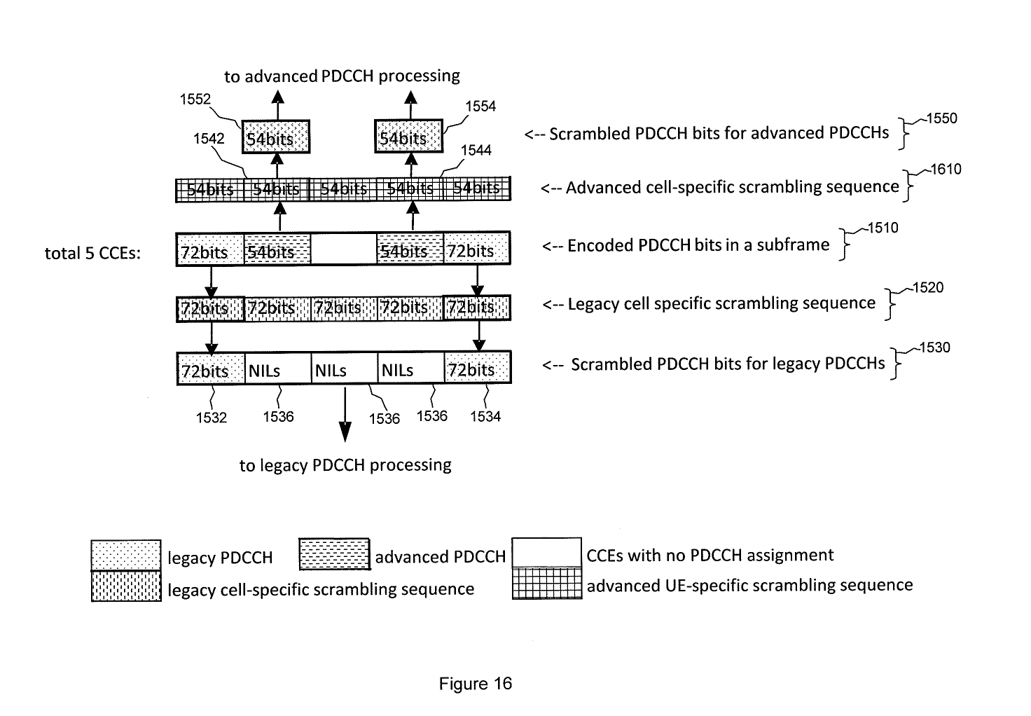

In an alternative embodiment, an advanced cell-specific scrambling sequence could be used to scramble the advanced PDCCHs. As shown in FIG. 16, a single scrambling sequence of length 5×54 bits in row 1610 is generated. The encoded PDCCH bits at row 1510 for the two advanced UEs are then scrambled by the corresponding bits of the scrambling sequence at the same bit positions, resulting in scrambled PDCCH bits for advanced PDCCHs at row 1550, as in FIG. 15. The scrambling sequence at row 1610 is cell-specific in the sense that no distinction is made at this point between CCEs intended for different advanced UEs in that cell.

The length of the advanced scrambling sequence in row 1610 could be different from that of the Rel-8 scrambling sequence based on several factors. First, scrambling does not need to be applied to the UE-PDCCH-DMRS. Second, higher order modulation may be applied to advanced PDCCHs, which results in more scrambling bits. Similar to the scrambling for legacy PDCCHs, this scrambling sequence might be applied only to advanced PDCCHs and might skip legacy PDCCHs.

Returning to FIG. 14, the modulation procedure at block 1430 will now be considered. The same modulation method used in Rel-8 can be used for modulation of the scrambled bits \tilde{b}₀, \tilde{b}₁, . . . , \tilde{b}_{M}_{_{bit}}₋₁. The resulting QPSK symbols can be denoted as d(0), . . . , d(M_{symb}−1), where M_{symb} is the number of QPSK symbols. Alternatively, higher modulation such as 16QAM may be used.

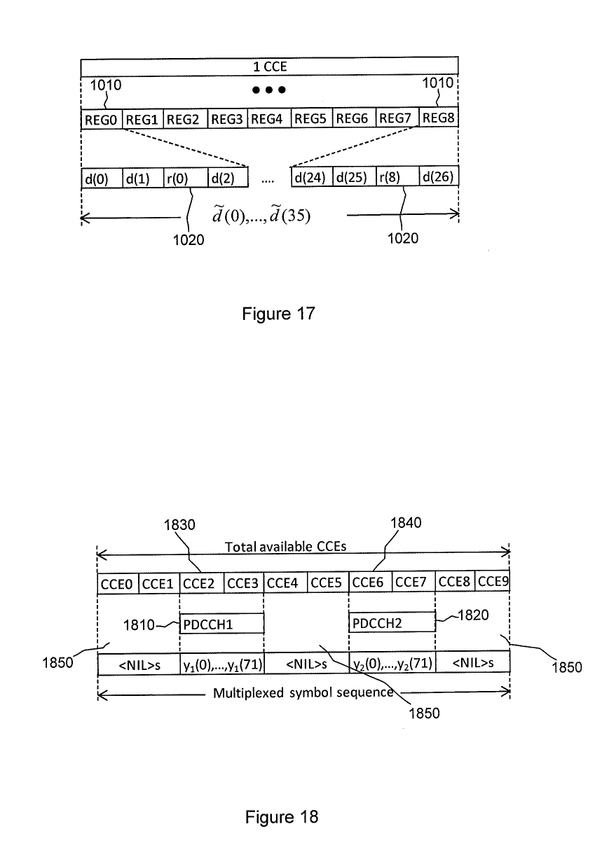

In the UE-PDCCH-DMRS insertion procedure at block 1440, a UE-PDCCH-DMRS is inserted into one of the REs in an REG, as shown in FIG. 10. More specifically, UE-PDCCH-DMRS symbols, r(0), . . . , r(Mᵣ−1), are inserted into d(0), . . . , d(m_{symb}−1), resulting in a new symbol sequence, \tilde{d}(0), . . . , \tilde{d}(\tilde{M}_{symb}−1), as follows:

$$\tilde{d} ( 4 k + m ) = \{ \begin{matrix}d ( 3 k + m ) , & for m \neq {K}_{DMRS} \\ r ( k ) , & for m = {K}_{DMRS} ;\end{matrix} \\ m = 0 , 1 , 2 , 3 ; k = 0 , 1 , … , 9 {L}_{PDCCH} - 1$$

where K_{DMRS}ε{0, 1, 2, 3} is the UE-PDCCH-DMRS RE location within each REG, L_{PDCCH} is the aggregation level of the PDCCH, and \tilde{M}_{symb}=36L_{PDCCH}. An example with L_{PDCCH}=1 and K_{DMRS}=2 is shown in FIG. 17. In this case, every third RE 1020 in an REG 1010 contains a UE-PDCCH-DMRS.

Returning to FIG. 14, in the layer mapping procedure at block 1450, the layer mapping method defined in Rel-8 for a single layer transmission can be applied to \tilde{d}(0), . . . , \tilde{d}(\tilde{M}_{symb}−1), i.e.,

x(i)=\tilde{d}(i), i=0, 1, . . . , \tilde{M}_{symb}−1.

In the precoding procedure at block 1460, each symbol x(i) can be precoded with a precoding vector \vec{w}(i)=[w⁽⁰⁾(i), . . . , w^{(P-1)}(i)]^{T}, i.e.,

\vec{y}(i)=\vec{w}(i)·x(i), i=0, . . . , \tilde{M}_{symb}−1

where \vec{y}(i)=[y⁽⁰⁾(i) . . . y^{(P-1)}(i)]^{T}, (.)^{T} denotes transpose, and y^{(p)}(i) and w^{(p)}(i) represent the signal and weighting factor for antenna port p, respectively. That is, x(i) represents data and \vec{w}(i) represents a precoding weight. The precoding performed at block 1460 is a new procedure implemented to deal with advanced PDCCHs; precoding was performed differently for legacy PDCCHs. Previously, if a single antenna was used for a legacy PDCCH, the transmission would occur without any precoding or other modification. If two antennas were used for a legacy PDCCH, transmit diversity would be employed, which uses a different precoding scheme.

The procedure at block 1470 for multiplexing of PDCCHs with the UE-PDCCH-DMRS will now be considered. Let {yᵢ^{(p)}(0), yᵢ^{(p)}(1), . . . , yᵢ^{(p)}(\tilde{M}_{symb,i}−1)} (i=0, 1, . . . , n_{PDCCH}^{(p)}−1.) be the precoded symbols of the i^{th} PDCCH channel at the p^{th} antenna port of the TP under consideration, where \tilde{M}_{symb,i} is the number of symbols to be transmitted on the i^{th} PDCCH channel and n_{PDCCH}^{(p)} is the number of PDCCHs with the UE-PDCCH-DMRS to be transmitted in the subframe over the p^{th} antenna port. The symbols from all the PDCCH channels are then multiplexed, resulting in a new symbol sequence ŷ^{(p)}(0), ŷ^{(p)}(1), . . . , ŷ^{(p)}(\hat{M}_{y}−1) as follows:

ŷ^{(p)}(36n_{CCE}⁽i)+m)=yᵢ^{(p)}(m), m=0, 1, . . . , \tilde{M}_{symb,i}−1

where n_{CCE}⁽ⁱ⁾ is the starting CCE index of the i^{th} PDCCH determined based on the Rel-8 PDCCH procedure. For indices that are not mapped to any of PDCCH channels, <NIL> elements can be inserted.

Let {CCE0, CCE1, . . . , CCE_{N}_{_{CCE}}₋₁} be the total number of available CCEs in a subframe. The starting CCE index, n_{CCE}⁽ⁱ⁾, for the i^{th} PDCCH can then be determined based on the Rel-8 PDCCH procedure and M_{y}=36N_{CCE}. An example is shown in FIG. 18, where N_{CCE}=10, n_{PDCCH}=2, n_{CCE}⁽⁰⁾=2 and n_{CCE}⁽¹⁾=6. That is, PDCCH1 1810 and PDCCH2 1820 might be advanced PDCCHs that are intended for different UEs and that are to be multiplexed together. Applying the formulas given above might result in PDCCH1 1810 starting at CCE2 1830 and PDCCH2 1820 starting at CCE6 1840. Legacy PDCCHs might be multiplexed into the gaps 1850 around and/or between PDCCH1 1810 and PDCCH2 1820 at block 1470 or at block 1490 of FIG. 14, as described below.

Returning to FIG. 14, the resource element mapping procedure at block 1480 will now be considered. Let z^{(p)}(i)= [symbol] ŷ^{(p)}(4i),ŷ^{(p)}(4i+1),ŷ^{(p)}(4i+2),ŷ^{(p)}(4i+3) [symbol] denote the symbol quadruplet i for antenna port p. The mapping from z^{(p)}(0), . . . , z^{(p)}(M_{quad}−1) where M_{quad}=\hat{M}_{y}/4, to REGs can be the same as is done in Rel-8.

In block 1490, advanced PDCCHs are multiplexed with legacy PDCCHs. After mapping to the resource elements in the control channel region in a subframe is done, PDCCHs with the UE-PDCCH-DMRS and legacy PDCCHs can be mapped to different REs. Thus, multiplexing of the two sets of PDCCHs in the control region is effectively done as well. Alternatively, legacy PDCCHs could be multiplexed with PDCCHs with the UE-PDCCH-DMRS in the same way as that described with regard to the multiplexing performed at block 1470. The order of the PDCCHs in a sequence could depend on the identities of the UEs that the PDCCHs are intended for.

The processing that occurs after block 1490, such as CRS insertion and OFDM signal generation, can be the same as in Rel-8, as indicated by the dashed lines around those subsequent blocks.

It may be necessary for a UE to determine whether a legacy PDCCH or an advanced PDCCH has been assigned to the UE. In an embodiment, the same PDCCH assignment procedure defined in Rel-8/9/10 can be used for a PDCCH with the UE-PDCCH-DMRS. For clarity, this procedure is now repeated. Let N_{CCE,k} be the total number of CCEs in the control region of subframe k. The CCEs can be numbered from 0 to N_{CCE,k}−1. The UE can monitor a set of PDCCH candidates for control information in every non-DRX (discontinuous reception) subframe, where monitoring implies attempting to decode each of the PDCCHs in the set according to all the monitored DCI (downlink channel information) formats.

The set of PDCCH candidates to monitor is defined in terms of search spaces, where a search space Sₖ^{(L)} at aggregation level Lε{1,2,4,8} is defined by a set of PDCCH candidates. The CCEs corresponding to PDCCH candidate m of the search space Sₖ^{(L)} are given by

L·{(Yₖ+m)mod └N_{CCE,k}/L┘}+i

where Yₖ is defined in the following paragraphs, i=0, . . . , L−1 and m=0, . . . , M^{(L)}−1. M^{(L)} is the number of PDCCH candidates to monitor in the given search space. The UE can monitor one UE-specific search space at each of the aggregation levels 1, 2, 4, 8 and one common search space at each of the aggregation levels 4 and 8. The aggregation levels defining the search spaces are listed in Table 3 in FIG. 20. The DCI formats that the UE monitors depend on the configured transmission mode as defined in Rel-8/9/10.

For the common search spaces, Yₖ is set to 0 for the two aggregation levels L=4 and L=8. For the UE-specific search space Sₖ^{(L)} at aggregation level L, the variable Yₖ is defined by

Yₖ=(A·Yₖ₋₁)mod D

where Y₋₁=n_{RNTI}≠0, A=39827, D=65537 and k=└nₛ/2┘, nₛε{0, 1, 2 . . . , 19} is the slot number within a radio frame. The RNTI value used for n_{RNTI} is the C-RNTI or SPS-RNTI defined in Rel-8/9/10.

As the UE procedure for PDCCH assignment has no changes from Rel-8, the PDCCH of a legacy UE and an advanced UE could be multiplexed the same way as in Rel-8, thus making the introduction of the advanced PDCCH transparent to the legacy UE.

By default, an advanced UE should follow the legacy Rel-8 procedure for PDCCH detection if there is no UE-PDCCH-DMRS. An advanced UE may be semi-statically configured by a higher layer to decode the UE-specific PDCCH with the CRC scrambled by the C-RNTI, or other types of RNTI configured by the eNB, by assuming one of three configurations. In a first configuration, the UE is semi-statically configured to assume it will receive a legacy PDCCH and will thus attempt to use only the CRS for demodulation. This configuration might be used when it is known that the UE is not near an RRH. In a second configuration, the UE is semi-statically configured to assume it will receive an advanced PDCCH and will thus attempt to use only the UE-PDCCH-DMRS for demodulation. This configuration might be used when it is known that the UE is near an RRH. In a third configuration, no signaling is performed to inform the UE which type of PDCCH it should expect. Instead, the UE might assume that it could receive either a legacy PDCCH or an advanced PDCCH and that it could need to use either the CRS or the UE-PDCCH-DMRS for demodulation.

Because the Rel-8 CCE allocation method and aggregation levels can be used for a PDCCH with the UE-PDCCH-DMRS, the maximum number of blind decodings for PDCCH detection in a subframe is the same for the first and second configurations. More blind decodings might be required for the third configuration. That is, the UE might first assume that it has received a legacy PDCCH that uses QPSK and has no UE-PDCCH-DMRS. If processing of the PDCCH using the CRS occurs correctly, the UE knows that the assumption of a legacy PDCCH was correct. If processing of the PDCCH does not occur correctly, the UE performs another round of blind decoding assuming that it has received an advanced PDCCH and using the UE-PDCCH-DMRS.

As a UE-specific PDCCH could be transmitted in both the common search space and the UE-specific search space, the third configuration could be applied in both these search spaces. An advanced UE might always decode the PDCCH with the CRC scrambled by special RNTIs (e.g., SI-RNTI, P-RNTI, TPC-RNTI, etc.) assuming a legacy PDCCH in the common search space.

A UE typically performs channel estimation based on a reference signal received from the macro-eNB. For legacy PDCCH demodulation, the UE uses the CRS for channel estimation. For advanced PDCCH demodulation, the UE-PDCCH-DMRS is used for channel estimation. In an embodiment, when a UE is configured to detect a PDCCH with the UE-PDCCH-DMRS, the UE can perform the following steps in each subframe to detect a UE-specific PDCCH with the CRC scrambled by the C-RNTI in both the UE-specific search space and the common search space:

Determine the number of CCEs in the control region.

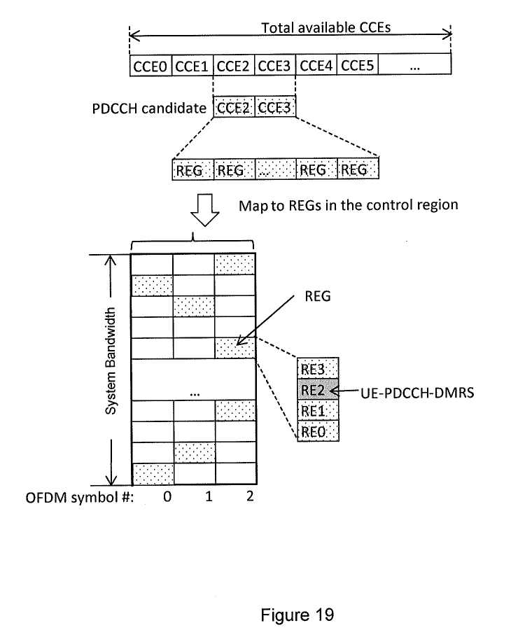

For each aggregation level (L=1, 2, 4, 8):
Set m=0;
If in <M^{(L)}, where M^{(L)} is the number of PDCCH candidates to be monitored:
   Determine the CCEs of the next PDCCH candidate (as is done in Rel-8);
   Identify the REGs that make up the CCEs (as is done in Rel-8);
   For each receive antenna port at the UE:
      Extract the UE-PDCCH-DMRS RE from each of the REGs as shown in FIG. 19 (as described below),
      Perform channel estimation on the UE-PDCCH-DMRS RE (as described below);
   Perform MRC (maximum ratio combining) and equalization on each REG using the channel estimation from the corresponding UE-PDCCH-DMRS RE (as described below);
   Perform demodulation of the equalized symbols over all the REGs (as is done in Rel-8);
   Perform de-scrambling (as described below);
   Perform channel decoding by assuming a UL or DL DCI format based on the UL and DL transmission modes assigned to the UE (as is done in Rel-8);
   Check CRC to see if a correct PDCCH is detected (as is done in Rel-8);

m=m+1.

The signals received on antenna port p of a UE for the i^{th} RE of the k^{th} REG for a candidate PDCCH with aggregation level L as shown in FIG. 19 can be written as:

vₖ^{(p)}(i)=hₖ^{(p)}(i)·x(4k+i)+nₖ^{(p)}(i), i=0, 1, 2, 3; k=0, 1, . . . , 9L−1.

where hₖ^{(p)}(i) is the channel from the TP over which the PDCCH is transmitted to antenna port p at the UE, including the effect of precoding; x(4k+i) is the symbol to be detected at the RE and x(4k+i)=\tilde{d}(4k+i) if a PDCCH is transmitted on the CCEs for the UE, where \tilde{d}(4k+i) is the transmitted PDCCH symbol; L is the aggregation level of the candidate PDCCH; and nₖ^{(p)}(i) is the receive noise at antenna port p of the UE at the RE. Assuming the candidate PDCCH corresponds to an actually transmitted PDCCH and using FIG. 17 as an example, then \tilde{d}(4k+2)=r(k) is the UE-PDCCH-DMRS symbol. Thus, the channel at the UE-PDCCH-DMRS RE, hₖ^{(p)}(i=2), can be estimated as follows:

ĥₖ^{(p)}(2)=vₖ^{(p)}(2)/r(k)=hₖ^{(p)}(2)+nₖ^{(P)}(2)/r(k)

The second term on the right side of the equation is the channel estimation error due to receive noise.

Since REs within each REG are adjacent in frequency, the channels over these REs do not change significantly. Thus, the channels can be estimated using the estimated channel of the UE-PDCCH-DMRS RE, i.e., ĥₖ^{(p)}(i)≈ĥₖ^{(p)}(2), i=0, 1, 3. With this channel estimation, the MRC approach can be performed on vₖ^{(p)}(i) as follows:

$${v}_{k}^{MRC} ( i ) = {\sum }_{p} {( {\hat{h}}_{k}^{( p )} ( i ) )}^{*} {v}_{k}^{( p )} ( i ) / {\sum }_{p}^{ } {\vert {\hat{h}}_{k}^{( p )} ( i ) \vert}^{2} , \\ i = 0 , 1 , 3 ; k = 0 , 1 , … , 9 {L}_{CCE} - 1.$$

where (•)* indicates complex conjugate operation. The transmitted symbols can then be estimated as follows:

{tilde over (\hat{d}(4k+i)=vₖ^{MRC}(i), i=0, 1, 3; k=0, 1, . . . , 9L−1.

The estimation of the transmitted PDCCH symbols \hat{d}(k) (k=0, 1, . . . , 27L−1) can be obtained from {tilde over (\hat{d}(4k+i) by removing {tilde over (\hat{d}(4k+=r(k) from {tilde over (\hat{d}(4k+i) according to FIG. 17.

The estimated PDCCH symbols can be demodulated using either hard decision demodulation or soft decision demodulation. The output binary sequence or LLR (log likelihood ratio) sequence, g₀, g₁, . . . , g_{Q}, from the demodulation is descrambled by the same scrambling sequence as shown in FIG. 15 or FIG. 16 at the location of the CCEs for the candidate PDCCH. Descrambling is done by flipping the sign of gᵢ (i=0, 1, . . . , Q), i.e., from 0 to 1 or from 1 to 0, if the corresponding bit of the scrambling sequence is “1”.

The rest of the PDCCH detection might be the same as that for a legacy PDCCH.

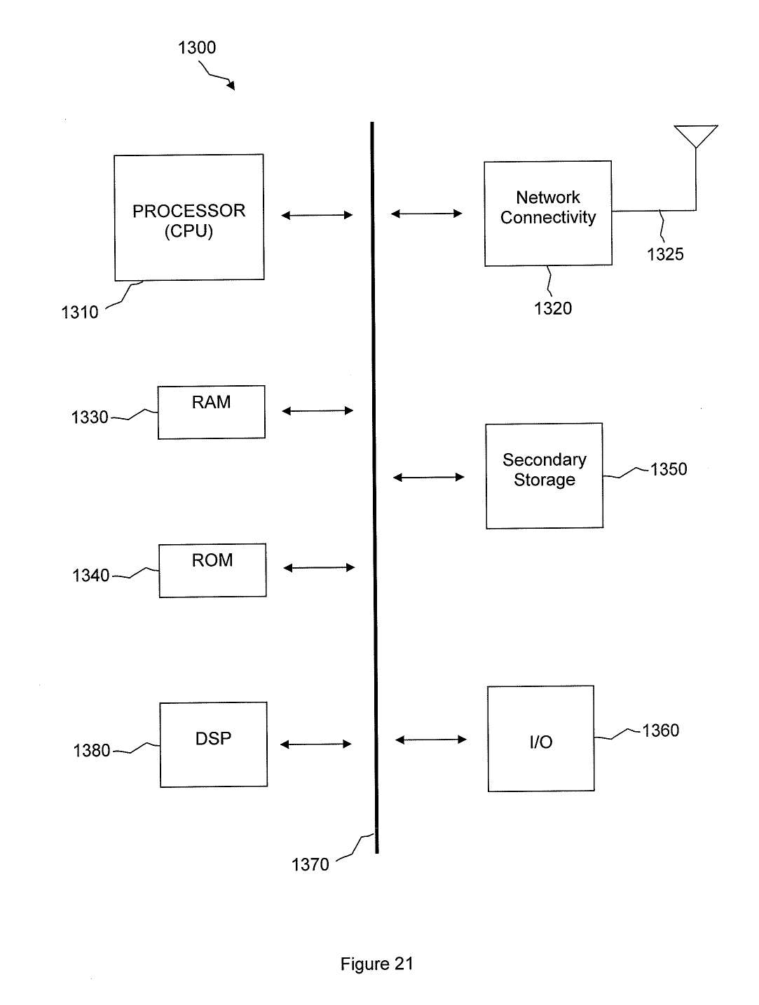

The UE and other components described above might include a processing component that is capable of executing instructions related to the actions described above. FIG. 21 illustrates an example of a system 1300 that includes a processing component 1310 suitable for implementing one or more embodiments disclosed herein. In addition to the processor 1310 (which may be referred to as a central processor unit or CPU), the system 1300 might include network connectivity devices 1320, random access memory (RAM) 1330, read only memory (ROM) 1340, secondary storage 1350, and input/output (I/O) devices 1360. These components might communicate with one another via a bus 1370. In some cases, some of these components may not be present or may be combined in various combinations with one another or with other components not shown. These components might be located in a single physical entity or in more than one physical entity. Any actions described herein as being taken by the processor 1310 might be taken by the processor 1310 alone or by the processor 1310 in conjunction with one or more components shown or not shown in the drawing, such as a digital signal processor (DSP) 1380. Although the DSP 1380 is shown as a separate component, the DSP 1380 might be incorporated into the processor 1310.

The processor 1310 executes instructions, codes, computer programs, or scripts that it might access from the network connectivity devices 1320, RAM 1330, ROM 1340, or secondary storage 1350 (which might include various disk-based systems such as hard disk, floppy disk, or optical disk). While only one CPU 1310 is shown, multiple processors may be present. Thus, while instructions may be discussed as being executed by a processor, the instructions may be executed simultaneously, serially, or otherwise by one or multiple processors. The processor 1310 may be implemented as one or more CPU chips.

The network connectivity devices 1320 may take the form of modems, modem banks, Ethernet devices, universal serial bus (USB) interface devices, serial interfaces, token ring devices, fiber distributed data interface (FDDI) devices, wireless local area network (WLAN) devices, radio transceiver devices such as code division multiple access (CDMA) devices, global system for mobile communications (GSM) radio transceiver devices, universal mobile telecommunications system (UMTS) radio transceiver devices, long term evolution (LTE) radio transceiver devices, worldwide interoperability for microwave access (WiMAX) devices, and/or other well-known devices for connecting to networks. These network connectivity devices 1320 may enable the processor 1310 to communicate with the Internet or one or more telecommunications networks or other networks from which the processor 1310 might receive information or to which the processor 1310 might output information. The network connectivity devices 1320 might also include one or more transceiver components 1325 capable of transmitting and/or receiving data wirelessly.

The RAM 1330 might be used to store volatile data and perhaps to store instructions that are executed by the processor 1310. The ROM 1340 is a non-volatile memory device that typically has a smaller memory capacity than the memory capacity of the secondary storage 1350. ROM 1340 might be used to store instructions and perhaps data that are read during execution of the instructions. Access to both RAM 1330 and ROM 1340 is typically faster than to secondary storage 1350. The secondary storage 1350 is typically comprised of one or more disk drives or tape drives and might be used for non-volatile storage of data or as an over-flow data storage device if RAM 1330 is not large enough to hold all working data. Secondary storage 1350 may be used to store programs that are loaded into RAM 1330 when such programs are selected for execution.

The I/O devices 1360 may include liquid crystal displays (LCDs), touch screen displays, keyboards, keypads, switches, dials, mice, track balls, voice recognizers, card readers, paper tape readers, printers, video monitors, or other well-known input/output devices. Also, the transceiver 1325 might be considered to be a component of the I/O devices 1360 instead of or in addition to being a component of the network connectivity devices 1320.

In an embodiment, a method is provided for transmitting data scheduling information from at least one transmission point in a cell in a wireless telecommunication system. The method comprises, in a procedure for generating a PDCCH, the at least one transmission point inserting a DMRS into at least one resource element in at least one REG in at least one CCE that contains the PDCCH, wherein the PDCCH is intended only for at least one specific UE.

In another embodiment, a transmission point is provided. The transmission point comprises a processor configured such that, in a procedure for generating a PDCCH, the transmission point inserts a DMRS into at least one resource element in at least one REG in at least one CCE that contains the PDCCH, wherein the PDCCH is intended only for at least one specific UE.

In another embodiment, a UE is provided. The UE includes a processor configured such that the UE receives a DMRS that has been inserted into at least one resource element in at least one resource element group in at least one control channel element that contains a PDCCH intended for at least the UE.

The following are incorporated herein by reference for all purposes: 3GPP Technical Specification (TS) 36.211 and 3GPP TS 36.213.

While several embodiments have been provided in the present disclosure, it should be understood that the disclosed systems and methods may be embodied in many other specific forms without departing from the scope of the present disclosure. The present examples are to be considered as illustrative and not restrictive, and the intention is not to be limited to the details given herein. For example, the various elements or components may be combined or integrated in another system or certain features may be omitted, or not implemented.

Also, techniques, systems, subsystems and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

What is claimed is:

1. A method for transmitting data scheduling information from at least one transmission point in a cell in a wireless telecommunication system, the method comprising:
in a procedure for generating a physical downlink control channel (PDCCH), the at least one transmission point inserting a demodulation reference signal (DMRS) into at least one resource element in at least one resource element (REG) group in at least one control channel element (CCE) that contains the PDCCH, wherein the PDCCH is intended only for at least one specific user equipment (UE).

2. The method of claim 1, wherein a first number of bits in a first CCE used for a first PDCCH into which the DMRS has been inserted is different from a second number of bits in a second CCE used for a second PDCCH into which the DMRS has not been inserted, and wherein the first CCE is multiplexed with the second CCE, and wherein a first bit-scrambling procedure is applied to the first CCE and a second bit-scrambling procedure is applied to the second CCE.

3. The method of claim 2, wherein the first bit-scrambling procedure is applied to the first CCE with a first bit-scrambling sequence.

4. The method of claim 2, wherein the first bit-scrambling procedure is applied to the first CCE with a first bit-scrambling sequence at a starting index of scrambling bits as if the second CCE has the same number of bits as the first CCE.

5. The method of claim 2, wherein the second bit-scrambling procedure is applied to the second CCE with a second bit-scrambling sequence at a starting index of scrambling bits as if the first CCE has the same number of bits as the second CCE.

6. The method of claim 2, wherein the first bit-scrambling sequence is at least partially based on an identifier for the UE

7. The method of claim 2, wherein the second bit-scrambling sequence is common for all UEs in the cell.

8. The method of claim 1, wherein a transmit power for the at least one resource element is different from a transmit power for at least one other resource element in the at least one resource element group, and wherein the transmission point informs the UE of the difference in power.

9. The method of claim 1, wherein an eight-bit cyclic redundancy code is used for the PDCCH.

10. The method of claim 1, wherein precoding is performed on the PDCCH, and the same precoding is performed on the inserted DMRS.

11. The method of claim 10, wherein the precoding vector is at least one of:
the same from REG to REG;
different from REG to REG;
predetermined; and
fed back from the UE

12. A transmission point, comprising:
a processor configured such that, in a procedure for generating a physical downlink control channel (PDCCH), the transmission point inserts a demodulation reference signal (DMRS) into at least one resource element in at least one resource element group (REG) in at least one control channel element (CCE) that contains the PDCCH, wherein the PDCCH is intended only for at least one specific user equipment (UE).

13. The transmission point of claim 12, wherein a first number of bits in a first CCE used for a first PDCCH into which the DMRS has been inserted is different from a second number of bits in a second CCE used for a second PDCCH into which the DMRS has not been inserted, and wherein the first CCE is multiplexed with the second CCE, and wherein a first bit-scrambling procedure is applied to the first CCE and a second bit-scrambling procedure is applied to the second CCE.

14. The transmission point of claim 13, wherein the first bit-scrambling procedure is applied to the first CCE with a first bit-scrambling sequence.

15. The transmission point of claim 13, wherein the first bit-scrambling procedure is applied to the first CCE with a first bit-scrambling sequence at a starting index of scrambling bits as if the second CCE has the same number of bits as the first CCE.

16. The transmission point of claim 13, wherein the second bit-scrambling procedure is applied to the second CCE with a second bit-scrambling sequence at a starting index of scrambling bits as if the first CCE has the same number of bits as the second CCE.

17. The transmission point of claim 13, wherein the first bit-scrambling sequence is at least partially based on an identifier for the UE

18. The transmission point of claim 13, wherein the second bit-scrambling sequence is common for all UEs in a cell.

19. The transmission point of claim 12, wherein a transmit power for the at least one resource element is different from a transmit power for at least one other resource element in the at least one resource element group, and wherein the transmission point informs the UE of the difference in power.

20. The transmission point of claim 12, wherein an eight-bit cyclic redundancy code is used for the PDCCH.

21. The transmission point of claim 12, wherein precoding is performed on the PDCCH, and the same precoding is performed on the inserted DMRS.

22. The transmission point of claim 21, wherein the precoding vector is at least one of:
the same from REG to REG;
different from REG to REG;
predetermined; and
fed back from the UE

23. A user equipment (UE), comprising:
a processor configured such that the UE receives a demodulation reference signal (DMRS) that has been inserted into at least one resource element in at least one resource element group in at least one control channel element that contains a physical downlink control channel (PDCCH) intended for at least the UE.

24. The UE of claim 23, wherein a first number of bits in a first CCE used for a first PDCCH into which the DMRS has been inserted is different from a second number of bits in a second CCE used for a second PDCCH into which the DMRS has not been inserted, and wherein the first CCE is multiplexed with the second CCE, and wherein a first bit-scrambling procedure is applied to the first CCE and a second bit-scrambling procedure is applied to the second CCE.

25. The UE of claim 24, wherein the first bit-scrambling procedure is applied to the first CCE with a first bit-scrambling sequence.

26. The UE of claim 24, wherein the first bit-scrambling procedure is applied to the first CCE with a first bit-scrambling sequence at a starting index of scrambling bits as if the second CCE has the same number of bits as the first CCE.

27. The UE of claim 24, wherein the second bit-scrambling procedure is applied to the second CCE with a second bit-scrambling sequence at a starting index of scrambling bits as if the first CCE has the same number of bits as the second CCE.

28. The UE of claim 24, wherein the first bit-scrambling sequence is at least partially based on an identifier for the UE

29. The UE of claim 24, wherein the second bit-scrambling sequence is common for all UEs in a cell.

30. The UE of claim 23, wherein a transmit power for the at least one resource element is different from a transmit power for at least one other resource element in the at least one resource element group, and wherein the UE receives information regarding the difference in power.

31. The UE of claim 23, wherein the UE receives one of:
a semi-static configuration wherein the UE uses a cell-specific reference signal for demodulation;
a semi-static configuration wherein the UE uses the DMRS for demodulation; and
no configuration regarding a reference signal to be used for demodulation.

32. The UE of claim 31, wherein, when the UE receives no configuration regarding a reference signal to be used for demodulation, the UE attempts to use the cell-specific reference signal for demodulation, and when the attempt to use the cell-specific reference signal for demodulation is unsuccessful, the UE attempts to use the DMRS for demodulation.

33. The UE of claim 23, wherein the UE uses the DMRS for channel estimation.
